(19) United States
(12) Patent Application Publication
(10) Pub. No.: US 2026/0109865 A1
(43) Pub. Date: Apr. 23, 2026

(54) WATER-BORNE COATING COMPOSITION

(71) Applicant: AXALTA COATING SYSTEMS IP CO., LLC, Wilmington, DE (US)

(72) Inventors: Shi Jun Yang, Maple Glen, PA (US); Lukman Solola, Philadelphia, PA (US); Eric Houze, Mullica Hill, NJ (US); Carmen Flosbach, Wuppertal (DE); Cen Lin, Claymont, DE (US); Beatrice Markiewicz, Philadelphia, PA (US)

(73) Assignee: AXALTA COATING SYSTEMS IP CO., LLC, Wilmington, DE (US)

(21) Appl. No.: 19/362,744

(22) Filed: Oct. 20, 2025

Related U.S. Application Data
(60) Provisional application No. 63/709,854, filed on Oct. 21, 2024.

(51) Int. Cl. C09D 5/02; C08F 265/06; C09D 151/06

(52) U.S. Cl. CPC C09D 5/022; C08F 265/06; C09D 151/06; C08F 2810/20

(57) ABSTRACT

A water-borne coating composition is provided. The water-borne coating composition includes water, a binder, and a crosslinker. The binder comprises (a1) a core-shell latex copolymer having pendant carbonyl groups. The crosslinker comprises (b1) at least one polyhydrazide compound having at least two hydrazide groups of the formula —C(═O)—NH—N(R^{h})(Rⁱ), wherein R^{h} and Rⁱ are independently H or C₁-C₁₂ alkyl. The molar ratio of hydrazide groups to carbonyl groups in the composition is from 5:1 to 1:5.

### CROSS REFERENCE TO RELATED APPLICATION

This application claims priority to U.S. Provisional Application No. 63/709,854, filed Oct. 21, 2024, the content of which is incorporated herein by reference.

### TECHNICAL FIELD

The present disclosure is directed to water-borne coating composition comprising: a binder comprising a core-shell latex copolymer having pendant carbonyl groups; and, a crosslinker comprising at least one polyhydrazide compound having at least two hydrazide groups. The coating composition has particular utility as a primer in automotive refinishing.

### BACKGROUND

The term “automotive refinish” refers to compositions and processes used in the repair of a damaged automotive finish, typically but not necessarily an original equipment manufacturer (OEM) provided finish. The damaged automotive component will contain defect area(s) wherein previously applied coating layers have been at least partially removed: such removal may in certain circumstances have exposed the bare substrates of the component. Refinish operations may thus involve the repair or replacement of the entire damaged automotive body component, the repair of one or more coating layers disposed on said components, or a combination of both operations. The size of the defect area and the presence or absence of coatings layers surrounding the defect area—which, if present, can act as anchors to refinishing coating compositions—are often determinative of the type of operation which is conducted.

As regards the repair of coating layers, the refinish process generally comprises the sequential steps of: sanding the surface to be refinished; applying at least one coat of a primer composition; optionally, sanding the applied primer composition; applying at least one basecoat to achieve the desired optical appearance, such as the desired color, gloss or distinctiveness of image (DOI); and, optionally applying a clearcoat composition.

As used herein the term “primer” is intended to encompass both primers and primer-surfacers. Further, as used herein, “topcoat” refers to any protective or decorative coating applied over a primer coating layer in a refinish operation, including but not limited to tie-coats, basecoats, pigmented basecoats, and clearcoats.

The primer coating layers are applied to promote adhesion between the substrate surface and the subsequent coating layers. Moreover, the primer coating layers may serve to enhance the physical properties of the overall coating system, in particular the corrosion resistance and the impact strength thereof. Still further, the primer coating layers can contribute to the overall appearance of the coating system by providing a smooth layer upon which the subsequent layers may be applied.

Historically, primer coating compositions have been solvent-borne and thus contained significant amounts of volatile organic compounds (VOC). However, due to environmental considerations, there has been a regulatory drive to reduce the level of such volatile organic compounds in inter alia automobile refinish coatings. For instance, in the United States, volatile organic compound emission standards are governed by Section 183(e) of the Clean Air Act (Act) and, as regards the enforceable emission levels for automobile refinish coatings, reference may be made to 42 United States Code (U.S.C.) § 7511b(e) and 40 Code of Federal Regulations (CFR) Part 59 Subpart B.

One mechanism to reduce VOC content has been the use so-called “high solids” primer compositions, wherein the level of organic solvent is reduced relative to the constituent weight of binder and any pigments and fillers also present. Problematically, high viscosity is a corollary to high solids content and this is associated with difficulties in the application of the compositions: poor flow of the compositions limits the methods by which such compositions may be applied and the levelling of the applied composition on the substrate surface may be ineffectual.

A second mechanism to reduce VOC content is to employ water-borne compositions. U.S. Pat. No. 8,461,253 B2 (Ambrose et al.), for example, describes a waterborne coating composition comprising: (a) acrylic copolymer resin particles comprising pendant carbonyl functionality; (b) a crosslinking agent comprising at least two functional groups reactive with the carbonyl functionality of the acrylic copolymer; and, (c) a non-reactive surfactant, wherein the acrylic copolymer resin particles are prepared in a single stage polymerization process and have a calculated glass transition temperature (Tg) of at least 40° C.

It is considered, however, that water-borne compositions can demonstrate inadequate moisture resistance, inadequate corrosion resistance and deficient or impermanent adhesion to the surface of metallic substrates. Waterborne primer compositions must fully dehydrate for proper crosslinking and curing to occur. Given its boiling point, the complete removal of water can be difficult to achieve though flash drying: water removal conventionally requires quite stringent baking conditions in which the movement of air and the humidity of the oven or drying booth must be carefully controlled. Drying can therefore present an energetic burden and can retard the refinishing process. However, inadequate drying can result in blistering, popping and the formation of pinholes as trapped moisture escapes from the cured coatings.

It would be desirable to develop water-borne primer compositions which demonstrate comparable properties to their solvent borne predecessors. More particularly, the water-borne primer compositions should exhibit good levelling on the application surface and be dehydratable—upon application—under moderate or low baking conditions. The cured primer coating should further be substantially free from blisters, pops or pinholes.

### BRIEF SUMMARY

In accordance with a first aspect of the disclosure there is provided a water-borne coating composition comprising:
water;
a) a binder comprising:
   (a1) a core-shell latex copolymer having pendant carbonyl groups, said core-shell latex copolymer comprising a core copolymer and a shell copolymer disposed about said core polymer, each of said core copolymer and said shell copolymer independently comprising the residues of:
      i) at least one (meth)acrylate monomer represented by Formula MA:

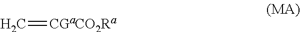

wherein: G^{a} is hydrogen, halogen or methyl; and,
R^{a} is: C₁-C₁₈ alkyl; C₂-C₁₈ heteroalkyl; C₃-C₁₈ cycloalkyl; C₂-C₈ heterocycloalkyl; C₂-C₈ alkenyl; C₂-C₈ alkynyl; C₆-C₁₈ aryl, C₁-C₉ heteroaryl, C₇-C₁₈ alkoxyaryl, C₇-C₁₈ alkaryl or C₇-C₁₈ aralkyl; and,
optionally ii) at least one vinyl aromatic monomer;
optionally iii) at least one monomer having at least two ethylenically unsaturated groups and having a weight average molecular weight (Mw) of at most about 600 Daltons;
optionally iv) at least one hydroxyl functional ethylenically unsaturated monomer;
wherein at least one of the core copolymer and shell copolymer comprises the residues of:
   v) at least one carbonyl functional ethylenically unsaturated monomer; and,
b) a crosslinker comprising:
   at least one polyhydrazide compound having at least two hydrazide groups of the formula —C(═O)—NH—N(R^{h})(Rⁱ), wherein R^{h} and Rⁱ are independently H or C₁-C₁₂ alkyl,
wherein the molar ratio of hydrazide groups to carbonyl groups in the composition is from about 5:1 to about 1:5.

In accordance with a second aspect of the disclosure, there is provided a cured product obtained from the water-borne coating composition as defined hereinabove and in the appended claims. The cured product demonstrates excellent drying properties marked by the absence of blistering, popping and pinholes in coatings thereof. Further, the cured product demonstrate excellent adhesion to the surface of metallic substrates such that the product can be subjected to mild sanding without delamination or adhesive failure.

The present disclosure also provides an article comprising: a metallic substrate; and, a multilayer coating disposed on the metallic substrate, wherein at least one layer of the multilayer coating comprises the cured product as defined hereinabove and in the appended claims. In an important embodiment of the article, the multilayer coating comprises: a primer layer comprising the cured product as defined hereinabove and in the appended claims, said primer layer being disposed on and in direct contact with the substrate; at least one base coat layer comprising a color and/or visual effect imparting compound, wherein at least one base coat layer is disposed on and in direct contact with the primer layer; and, a clear coat layer disposed on and in direct contact with at least one base coat layer.

Where the aspects of the disclosure are described herein as having certain embodiments, any one or more of those embodiments can, unless otherwise stated, be implemented in or combined with any one of the further embodiments, even if that combination is not explicitly described. Expressed differently, the described embodiments are not mutually exclusive unless stated as being such, and permutations thereof remain within the scope of this disclosure.

### BRIEF DESCRIPTION OF THE DRAWINGS

Various other objects, advantages, and features of the disclosure will become apparent to those skill in the art from the following discussion taken in conjunction with the appended drawings, in which:

FIG. 1 illustrates an article in accordance with a first embodiment of the present disclosure; and,

FIG. 2 illustrates an article in accordance with a second embodiment of the present disclosure.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Embodiments of the present disclosure are generally directed to core-shell latex copolymers, compositions including the same, and methods for forming the same. For the sake of brevity, conventional techniques related to making such polymers and such compositions may not be described in detail herein. Moreover, the various tasks and process steps described herein may be incorporated into a more comprehensive procedure or process having additional steps or functionality not described in detail herein. In particular, various steps in the manufacture of such polymers and associated compositions are well-known and so, in the interest of brevity, may conventional steps will only be described briefly or will be omitted entirely without providing the well-known process details.

The polymers and compositions disclosed herein may suitably comprise, consist of, or consist essentially of the components, elements, and process delineations described herein. The embodiments illustratively disclosed herein suitably may be practiced in the absence of any element which is not specifically disclosed herein.

### Definitions

The terminology “consists essentially of” may describe various non-limiting embodiments that are free of one or more optional compounds described herein or one or more additives, solvents, polymers, resins etc. that are not described herein but that are utilized in the art.

The terminology “about” can describe values ±0.1, 0.5, 1, 2, 3, 4, 5, 6, 7, 8, 9 or 10% in various embodiments. Moreover, it is considered that, in various non-limiting embodiments, it is to be appreciated that all numerical values as provided herein, save for actual examples, are approximate values with endpoints or particular values intended to read as “about” or “approximately” the values as recited.

The molecular weights referred to in this specification are typically measured with gel permeation chromatography (GPC) using polystyrene calibration standards, such as is done according to ASTM 3536.

The “acid value” or “acid number” is a measure of the amount of free acid present in a compound: the acid value is the number of milligrams of potassium hydroxide required for the neutralization of free acid present in one gram of a substance (mg KOH/g). Any measured acid values given herein have been determined in accordance with German Standard DIN 53402.

The term “hydroxyl value” as used herein is defined as the mass in milligrams of potassium hydroxide required to neutralize the acetic acid taken up on acetylation of one gram of a chemical substance that contains free hydroxyl groups. Where stated, the hydroxyl number is analyzed in accordance with according to the standard test method ASTM D4274-11.

As used herein, the term softening point (° C.) used in regard to waxes herein is the Ring & Ball softening point, which is measured unless otherwise indicated according to ASTM E28.

Viscosities of the compositions described herein are, unless otherwise stipulated, measured using the Brookfield Viscometer, Model DVT2T at standard conditions of 20° C. and 50% Relative Humidity (RH). A set of RV spindles that attach to the viscometer are used for the calibration. Measurements of the coating compositions are done using the No. 3 spindle at a speed of 100 revolutions per minute for 1 minute until the viscometer equilibrates. The viscosity corresponding to the equilibrium reading is then calculated using the calibration.

Where mentioned, a calculated glass transition temperature (“T_{g}”) of a polymer or copolymer is that temperature which may be calculated by using the Fox equation:

$$1 / {T}_{g , polymer} \approx {\sum }_{i} {w}_{i} / {T}_{g , i}$$

where: T_{g,polymer} and T_{g,i} are the glass transition temperature of the (co-)polymer and of the component monomers (i) respectively; and, wᵢ is the mass fraction of component i. The glass transition temperatures of certain homo-polymers may be found in the published literature.

As used herein, a measured “glass transition temperature” (Tg) is determined by differential scanning calorimetry (DSC) employing a 20 K/min ramp rate and midpoint measurement in accordance with Deutsches Institut für Normung (DIN) 53 765.

As used herein, the term “minimum film-forming temperature” refers to the lowest temperature required to coalesce an aqueous polymer dispersion—a latex or emulsion—into a thin film when applied to a substrate. The minimum film forming temperature (MFFT) is determined herein according to ASTM D2354-98 using a Rhopoint Industries BAR-90.

Unless otherwise stated, the term “particle size” refers to the largest axis of the particle. In the case of a generally spherical particle, the largest axis is the diameter.

The term “mean volume particle size” (Dv50), as used herein, refers to a particle size corresponding to 50% of the volume of the sampled particles being greater than and 50% of the volume of the sampled particles being smaller than the recited Dv50 value. Particle size is determined herein by laser diffraction using Anton Paar Particle Size Analyzer (PSA) Litesizer 500.

As used herein, the term “solids content” refers to the percent by weight of non-volatile components in the composition. The solids content may be determined as the inverse value of the volatile content obtained in accordance with ASTM D2369 Standard Test Method for Volatile Content of Coatings.

As used herein, room temperature is 23° C. plus or minus 2° C.

As used herein, “ambient conditions” means the temperature and pressure of the surroundings in which the composition is located or in which a coating layer or the substrate of the coating layer is located.

“Multi-part compositions” in the context of the present disclosure are understood to be compositions comprising at least two parts which should be stored in separate vessels because of their (high) reactivity. The parts are mixed before or during application of the composition and then react, typically without additional activation, with bond formation and thereby formation of a polymeric network. Herein higher temperatures may be applied in order to accelerate the reaction of the parts.

The term “water-borne composition” as used herein refers to that composition which actually contacts the substrate to be primed. The term “water-borne” means that the solvent or carrier fluid for the composition primarily or principally comprises water, such that water constitutes at least 50% by weight, for example at least 60% by weight or at least 70% by weight, of the liquid continuous phase of the primer composition.

The term “water-dispersible (co)polymer” as used herein refers to a (co)polymer that exists in the form of particles in water, the particles being dispersed or suspended and being stable against flocculation upon further dilution with water. In contrast to a water-soluble (co)polymer, a dilute solution (about 1 g/L) of a water-dilutable polymer exhibits scattering when analyzed using dynamic light scattering or any other technique well known in the art of particle analysis.

The term “water” is used herein in accordance with its standard meaning. The water of the coating composition may be distilled water, demineralized water, deionized water, reverse osmosis water, boiler condensate water, or ultra-filtration water: tap water may be tolerated in certain circumstances.

As used herein, “curing” of the water-borne coating composition refers to the formation of a coating on a substrate: whilst the curing will include cross-linking reaction(s), it further encompasses: evaporation of water and, when present, co-solvent from the composition (drying); and, coalescence of the particulate or dispersed phase of the composition. Such curing may be performed under ambient conditions or by deliberate exposure to heat and/or irradiation. The degree of cure may be partial or complete: the degree (%) of cross-linking can, in particular, be determined by dynamic mechanical thermal analysis (DMTA) using a TA Instruments RSA-G2 (FCO, LN2) under an inert gas atmosphere.

The term “sandpaper” as used herein encompasses a sheet material having abrasive particles carried by a flexible backing, such as a cloth, paper, skin or sheet material. Exemplary abrasive particles include: silica; garnet; emery; alumina; alumina-zirconia; and, silicon carbide. Sandpaper of from 80 to 400 grit may be mentioned as having particular utility in refinishing operations.

The term “clear coat” is used herein to denote a coating layer within a multilayer coating which is sufficiently transparent or translucent to enable the underlying coating layer(s) to be seen through it. The term “clear” has not require absolute transparency or translucency.

As used herein, “metallic” means any type of metal, metal alloy, or mixture thereof. As used herein, the term “alloy” refers to a substance composed of two or more metals or of a metal and a non-metal which have been intimately united, usually by being fused together and dissolved in each other when molten.

As used herein, the term “catalytic amount” means a sub-stoichiometric amount of catalyst relative to a reactant, except where expressly stated otherwise.

As used herein, the term “free radical initiator” refers to any chemical species which, upon exposure to sufficient energy—in the form of light or heat, for example—decomposes into two parts which are uncharged, but which each possess at least one unpaired electron. In particular, a free radical thermal initiator generates free radicals upon activation by thermal energy upon, for instance, heating or irradiation of the infrared or microwave wavelength regions.

All isomers and chiral options for each compound described herein are expressly contemplated for use herein in various non-limiting embodiments.

It will be understood that the subscripts of polymers are typically described as average values because the synthesis of polymers typically produces a distribution of various individual molecules.

As used herein, the term “monomer” refers to a substance that can undergo a polymerization reaction to contribute constitutional units to the chemical structure of a polymer. The term “monofunctional”, as used herein, refers to the possession of one polymerizable moiety. The term “multifunctional”, as used herein, refers to the possession of more than one polymerizable moiety.

The term “ethylenically unsaturated monomer” as used herein refers to any monomer containing a terminal double bond capable of polymerization under normal conditions of free-radical addition polymerization.

The term “active hydrogen atoms” refers to hydrogen atoms which display activity according to the Zerewitinoff test as described by Kohlerin J. Am. Chem. Soc., 49, 3181 (1927), which is expressly incorporated herein by reference in its entirety in various non-limiting embodiments. Active hydrogen atoms can be derived from hydroxyl, thiol, primary amine, secondary amine and carboxyl groups.

A “non-ionic polyol” as used herein is one that does not contain a hydrophilic ionizable group.

The term “blocked” as used herein refers to a compound that has been reacted with a second compound-possessing a “blocking group”-such that its reactive functionality is not available until such time as the blocking group is removed. The blocking group can be selectively removed at an appropriate point in the synthetic sequence: the triggering event may be inter alia moisture, heat or irradiation. Examples of blocked isocyanates include those that have been co-reacted with phenol, methyl ethyl ketoxime or ϵ-caprolactam.

As used herein, “(meth)acryl” is a shorthand term referring to “acryl” and/or “methacryl”. Thus the term “(meth)acrylate” refers collectively to acrylate and methacrylate.

As used herein, the term “keto group” refers to a group in which a carbonyl group is bonded to two carbon atoms. The keto group may be represented by the formula R₂C═O wherein neither R may be H.

The term “hydrocarbyl group” is used herein in its ordinary sense, which is well-known to those skilled in the art.

As used herein, “C₁-Cₙ alkyl” refers to a monovalent group or moiety having from 1 to n carbons atoms, that is a radical of an alkane and includes straight-chain and branched organic groups. As such, a “C₁-C₁₈ alkyl” refers to a monovalent group or moiety having from 1 to 18 carbons atoms, that is a radical of an alkane and includes straight-chain and branched organic groups. Examples of alkyl groups include: methyl; ethyl; propyl; isopropyl; n-butyl; isobutyl; sec-butyl; tert-butyl; n-pentyl; n-hexyl; n-heptyl; and, 2-ethylhexyl. In the present disclosure, such alkyl groups may be unsubstituted or may be substituted with one or more halogen. Where applicable for a given moiety (R), a tolerance for one or more non-halogen substituents within an alkyl group will be described in the specification.

The term “C₁-C₁₈ hydroxyalkyl” as used herein refers to an HO-(alkyl) group having from 1 to 18 carbon atoms, where the point of attachment of the substituent is through the oxygen-atom and the alkyl group is as defined above.

An “alkoxy group” refers to a monovalent group represented by —OA where A is an alkyl group: non-limiting examples thereof are a methoxy group, an ethoxy group and an iso-propyloxy group. The term “C₁-C₁₈ alkoxyalkyl” as used herein refers to an alkyl group or moiety having an alkoxy substituent as defined above and wherein the moiety (alkyl-O-alkyl) has in total from 1 to 18 carbon atoms: such groups include methoxymethyl (—CH₂OCH₃), 2-methoxyethyl (—CH₂CH₂OCH₃) and 2-ethoxyethyl. Analogously, the term “C₇-C₁₈ alkoxyaryl” as used herein refers to an aryl group having an alkoxy substituent as defined above and wherein the moiety (aryl-O-alkyl) comprises in total from 7 to 18 carbon atoms.

The term “C₂-C₄ alkylene” as used herein, is defined as saturated, divalent hydrocarbon radical having from 2 to 4 carbon atoms.

The term “C₃-C₁₈ cycloalkyl” encompasses a saturated, mono- or polycyclic hydrocarbon group or moiety having from 3 to 18 carbon atoms. In the present disclosure, such cycloalkyl groups or moieties may be unsubstituted or may be substituted with one or more halogen. Where applicable for a given moiety (R), a tolerance for one or more non-halogen substituents within a cycloalkyl group will be described in the specification. Examples of cycloalkyl groups include: cyclopropyl; cyclobutyl; cyclopentyl; cyclohexyl; cycloheptyl; cyclooctyl; adamantane; and, norbornane.

The term “C₃-C₁₈ cycloalkylene” as used herein refers to a saturated, divalent mono-, bi- or tricyclic hydrocarbon radical having from 3 to 18 carbon atoms. In the present disclosure, such cycloalkylene moieties may be unsubstituted or may be substituted with one or more halogen. Where applicable for a given moiety (R), a tolerance for one or more non-halogen substituents within a cycloalkylene group will be noted in the specification. Exemplary C₃-C₁₈ cycloalkylenes include cycloptopyl-1,1-diyl; cyclopropyl-1,2-diyl; cyclobuytl-1,2-diyl; cyclopentyl-1,3-diyl; cyclohexyl-1,4-diyl; cycloheptyl-1,4-diyl; and, cyclooctyl-1,5-diyl.

As used herein, “C₆-C₁₈ aryl” used alone or as part of a larger moiety—as in “aralkyl group”—refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present disclosure, such aryl groups may be unsubstituted or may be substituted with one or more halogen. Where applicable for a given moiety (R), a tolerance for one or more non-halogen substituents within an aryl group will be described in the specification. Exemplary aryl groups include: phenyl; (C₁-C₄)alkylphenyl, such as tolyl and ethylphenyl; indenyl; naphthalenyl, tetrahydronaphthyl, tetrahydroindenyl; tetrahydroanthracenyl; and, anthracenyl.

The term “C₆-C₁₈ arylene group” as used herein refers to a divalent radical having from 6 to 18 carbon atoms and which is derived from an monocyclic, bicyclic and tricyclic ring systems in which the monocyclic ring system is aromatic or at least one of the rings in a bicyclic or tricyclic ring system is aromatic. The arylene group may be substituted by at least one halogen substituent but the aromatic portion of the arylene group includes carbon atoms only. Where applicable for a given moiety (R), a tolerance for one or more non-halogen substituents within an arylene group will be noted in the specification. Exemplary “C₆-C₁₈ arylene” groups include phenylene and naphthalene-1,8-diyl.

As used herein, “alkylaryl” refers to alkyl-substituted aryl groups, both groups as defined above. Further, as used herein “aralkyl” means an alkyl group substituted with an aryl radical as defined above.

As used herein, “C₂-C₁₈ alkenyl” refers to hydrocarbyl groups or moieties having from 2 to 18 carbon atoms and at least one unit of ethylenic unsaturation. The alkenyl group or moiety can be straight chained, branched or cyclic and may optionally be substituted with one or more halogen. Where applicable for a given moiety (R), a tolerance for one or more non-halogen substituents within an alkenyl group will be described in the specification. The term “alkenyl” also encompasses radicals having “cis” and “trans” configurations, or alternatively, “E” and “Z” configurations, as appreciated by those of ordinary skill in the art. Examples of C₂-C₂₀ alkenyl groups include: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; C(CH₃)═CHCH₃; C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)═CHCH₂CH₃; —CH(CH₃)CH═CHCH: —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “C₂-C₁₂ alkenylene” refers to di-radical groups having from 2 to 24 carbon atoms and at least one unit of ethylenic unsaturation. The alkenylene radical can be straight chained, branched or cyclic and may optionally be substituted with one or more halogen. Where applicable for a given moiety (R), a tolerance for one or more non-halogen substituents within an alkenylene radical will be noted in the specification. The term “alkenylene” also encompasses radicals having “cis” and “trans” configurations, or alternatively, “E” and “Z” configurations, as appreciated by those of ordinary skill in the art. Examples of said C₂-C₁₂ alkenyl groups include, but are not limited to: ethenylene; ethen-1,1-diyl; propenylene; propen-1,1-diyl; prop-2-en-1,1-diyl; 1-methyl-ethenylene; but-1-enylene; but-2-enylene; but-1,3-dienylene; buten-1,1-diyl; but-1,3-dien-1,1-diyl; but-2-en-1,1-diyl; but-3-en-1,1-diyl; 1-methyl-prop-2-en-1,1-diyl; 2-methyl-prop-2-en-1,1-diyl; 1-ethyl-ethenylene; 1,2-dimethyl-ethenylene; 1-methyl-propenylene; 2-methyl-propenylene; 3-methyl-propenylene; 2-methyl-propen-1,1-diyl; and, 2,2-dimethyl-ethen-1,1-diyl.

The term “hetero” as used herein refers to groups or moieties containing one or more heteroatoms, such as N, O, Si and S. Thus, for example “heterocyclic” refers to cyclic groups having, for example, N, O, Si or S as part of the ring structure. “Heteroalkyl”, “heterocycloalkyl” and “heteroaryl” moieties are alkyl, cycloalkyl and aryl groups as defined hereinabove, respectively, containing N, O, Si or S as part of their structure.

In various embodiments, the term “free of” describes embodiments that include less than about 5, 4, 3, 2, 1, 0.5 or 0.1 wt. % of the component, compound, moiety, functional group, element or ion at issue using an appropriate weight basis as would be understood by one of skill in the art. In other embodiments, the term “free of” describes embodiments that have about 0 wt. % of the component, compound, moiety, functional group, element or ion at issue.

The term “anhydrous” as used herein has equivalence to the term “free of water”.

Referring back, the water-borne composition comprises water and: a) a binder; and, b) a crosslinker. The water may be present in an amount of from about 10 to about 70 wt. %, for example from about 20 to about 70 wt. % or from about 30 to about 60 wt. %, based on the weight of the composition. At this water content, the drying and coalescing of the composition—when applied to a substrate—may not be associated with high energetic and time costs. Compositions having this water content may be exemplified by a viscosity of less than from about 0.05 to about 2 Pa·s, from about 0.05 to about 1.5 Pa·s or from about 0.05 to about 1 Pa·s, as measured using a Brookfield Viscometer at 25° C. In various non-limiting embodiments, all values and ranges of values, both whole and fractional, including and between those set forth above are expressly contemplated for use herein.

The water-borne compositions of the present disclosure may be prepared as an one-part (1K) composition. In the alternative, the water-borne compositions may be prepared as a multi-part composition in which at least the core-shell latex copolymer (a1) and the polyhydrazide compound (b1) are provided in separate parts thereof. As regards a multi-part composition, the constituent water need not be added independently to any one or more parts or to the composition itself. Alternatively one or more parts of the composition may be provided in water.

In certain embodiments, that part of the multi-part composition which comprises the core-shell latex copolymer (a1) may further comprise water such that said part provides at least a fraction of the water of the multi-part composition. The core-shell latex copolymer of constituent (a1) is water-dilutable, which property can provide flexibility for an operator when applying the coating compositions in, for instance, vehicle refinishing operations. It is not precluded however that supplementary water be added to the composition during or after the core-shell latex copolymer (a1) and the polyhydrazide compound (b1) being brought together. The addition of this supplementary water may serve to reduce the viscosity of the composition, which may be useful for certain methods described below by which the composition is applied to substrates, such as spraying.

### Binder A)

The binder a) of the water-borne composition comprises: (a1) a core-shell latex copolymer having pendant carbonyl groups. In certain embodiments, the binder a) of the coating composition further comprises at least one (co)polymer which is distinct from the core-shell latex copolymer (a1) but which is reactive towards the polyhydrazide compounds present in the composition.

### (a1) Core-Shell Latex Copolymer

The water-borne composition comprises a core-shell latex copolymer having carbonyl groups. The composition may, for instance, contain from about 5 to about 50 wt. % or from about 10 to about 50 wt. % of (a1) said core-shell latex copolymer, based on the weight of the composition. In certain important embodiments, the core-shell latex copolymer should be included in the composition in an amount of from about 15 to about 45 wt. % or from about 20 to about 45 wt. %, based on the total weight of the composition. In various non-limiting embodiments, all values and ranges of values, both whole and fractional, including and between those set forth above are expressly contemplated for use herein.

As used herein, the term “core-shell latex copolymer” references a latex copolymer that is made in a staged polymerization process having at least two polymerization stages. In one of the stages, an emulsion polymerization process is conducted to produce the “core” copolymer. In another of the stages, an emulsion polymerization process is conducted to form the “shell” polymer. In an embodiment, the core copolymer is synthesized in a free-radical emulsion polymerization stage which precedes the stage of the synthesis of the shell copolymer by free-radical emulsion polymerization: the shell copolymer will typically be formed in the presence of particles of the core copolymer in these embodiments. In another embodiment, typically where the core copolymer is more hydrophobic than the shell copolymer, the stage of free-radical emulsion polymerization of the shell copolymer may precede the stage of the free-radical emulsion polymerization of the core copolymer. An exemplary process in accordance this latter embodiment is disclosed in U.S. Pat. No. 7,825,173 B2, the disclosure of which is herein incorporated by reference in its entirety.

There is a period of time between the core-forming stage and the shell-forming stage in which no detectable polymerization takes place. It is not however precluded that one or more additional polymerization stages to the core- and shell-forming stages may be conducted. Exemplary additional polymerization stages may occur: before that stage forming the core polymer; between the stage of core polymerization and the stage of shell polymerization; or, after the stage of shell polymerization.

The shell formed by the shell copolymer should cover the surface of the core copolymer at least partially and typically completely. The core and shell copolymers are physically and/or chemically bonded to each other and in some embodiments there may be interpenetration of the polymeric chains residing in the core and shell of the latex copolymer. However, the core-shell copolymer latex should possess a relatively well-defined change in polymeric structure or composition when moving outward along a radius of the latex particle from the center, yielding a morphology having a relatively distinct core portion comprising one polymeric composition, and a relatively distinct shell portion comprising a different polymeric composition.

In an important embodiment, the core-shell latex copolymer is exemplified in that the core copolymer accounts for at least about 10 wt. %, for instance from about 10 to about 70 wt. % or from about 10 to 50 wt. %, of the total weight of monomer residues in said core-shell latex copolymer. In various non-limiting embodiments, all values and ranges of values, both whole and fractional, including and between those set forth above are expressly contemplated for use herein.

Independently of or additional to the above property, the core-shell latex copolymer should be exemplified in that the core polymer has a higher glass transition temperature (Tg) than the shell polymer. In certain embodiments: the core copolymer has a calculated glass transition temperature (T_{g}) of from about 20 to about 80° C., such as from about 40 to about 80° C. or from about 50 to about 80° C.; and, the shell copolymer has a calculated glass transition temperature (T_{g}) of from about −30° C. to about 30° C., such as from about −30 to about 15° C. or from about −30 to about 0° C. In other embodiments, the calculated glass transition temperature of the core copolymer is at least about 20° C. or at least about 30° C. higher than the calculated glass transition temperature of the shell copolymer. In various non-limiting embodiments, all values and ranges of values, both whole and fractional, including and between those set forth above are expressly contemplated for use herein.

Independently of, or additional to the glass transition temperatures of the core and shell copolymers, it is typical that, based on the total of all monomer residues present, the core-shell latex copolymer has a calculated glass transition temperature of from about −20 to about 40° C.

In available literature, monomers may be defined by a glass transition temperature: strictly, this temperature represents the glass transition temperature of a homopolymer obtained from the homopolymerization of that monomer. The monomers of each sequential stage of polymerization will be chosen based on their glass transition temperature to attain the desired calculated glass transition temperature for the polymer of each stage and the core-shell latex copolymer in toto.

In an embodiment, which is not intended to be mutually exclusive of the property of glass transition temperature as mentioned above, the core-shell latex copolymer may be exemplified by a minimum film forming temperature of less than about 45° C., for example less than about 40° C., less than about 35° C. or less than about 30° C.

The core-shell latex copolymer of the composition typically has a mean volume particle size (dᵥ50) of from about 10 nm to about 1000 nm, for example from about 50 nm to about 500 nm or from about 50 to about 400 nm, as measured via laser diffraction. In various non-limiting embodiments, all values and ranges of values, both whole and fractional, including and between those set forth above are expressly contemplated for use herein.

For completeness, the present disclosure does not preclude the inclusion in the composition of two or more types of core-shell latex copolymer particles with different particle size distributions to provide a balance of key properties of the resultant cured product, including shear strength, peel strength and resin fracture toughness.

As noted above, the carbonyl-functional core-shell latex copolymers comprise at least two copolymers and are synthesized in sequential stages via free radical emulsion copolymerization. The monomers of each stage will be chosen to attain the desired polymer properties for each stage and, in toto, at least one of the reactant monomer mixture from which the core copolymer is formed and the reactant monomer mixture from which the shell copolymer is formed will comprise: iv) at least one hydroxyl functional ethylenically unsaturated monomer; and, v) at least one carbonyl functional ethylenically unsaturated monomer.

The following describes the candidate monomers for the synthesis of the core-shell latex copolymer. The term “complete monomer mixture” refers to those monomers of which the residues are present in the core-shell latex copolymer in toto: it represents the sum of the monomers present in the polymerization stages by which the core-shell latex copolymer is obtained. The percentage by weight that a given monomer component may contribute is given based on the total weight of monomer residues in the core-shell latex copolymer.

### Monomer Component i): Aliphatic (Meth)Acrylate Monomers of Formula MA

The complete monomer mixture comprises i) at least one ethylenically unsaturated functional monomer represented by Formula MA:

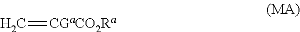

wherein: G^{a} is hydrogen, halogen or methyl; and,
   R^{a} is C₁-C₁₈ alkyl, C₂-C₁₈ heteroalkyl, C₃-C₁₈ cycloalkyl, C₂-C₈ heterocycloalkyl, C₂-C₈ alkenyl, C₂-C₈ alkynyl, C₆-C₁₈ aryl, C₁-C₉ heteroaryl, C₇-C₁₈ alkoxyaryl, C₇-C₁₈ alkaryl or C₇-C₁₈ aralkyl.

Monomer component i) may account for about 40 to about 95 wt. % or from about 50 to about 90 wt. % based on the total weight of monomer residues in the core-shell latex copolymer. In various non-limiting embodiments, all values and ranges of values, both whole and fractional, including and between those set forth above are expressly contemplated for use herein.

In an important embodiment, the complete monomer mixture comprises at least one ethylenically unsaturated functional monomer represented by Formula MA1:

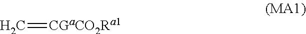

wherein: G^{a} is hydrogen, halogen or methyl; and,
   R^{a1} is C₁-C₁₈ alkyl, C₂-C₁₈ heteroalkyl, C₃-C₁₈ cycloalkyl, C₂-C₈ heterocycloalkyl, C₂-C₈ alkenyl or C₂-C₈ alkynyl.

Monomers of Formula MA1 may, in exemplary embodiments, contribute from about 50 to about 100 wt. % or from about 90 to about 100 wt. % of the total weight of monomers of Formula MA in the complete monomer mixture. In various non-limiting embodiments, all values and ranges of values, both whole and fractional, including and between those set forth above are expressly contemplated for use herein.

Typical monomers in accordance with Formula MA1 are those wherein: G^{a} is hydrogen, halogen or methyl; and, R^{a1} is C₁-C₁₈ alkyl or C₃-C₁₈ cycloalkyl. Monomers in which G^{a} is hydrogen or methyl may be used.

Examples of (meth)acrylate monomers in accordance with Formula MA1, which may be used alone or in combination, include but are not limited to: methyl (meth)acrylate; ethyl (meth)acrylate; butyl (meth)acrylate; hexyl (meth)acrylate; 2-ethylhexyl (meth)acrylate; dodecyl (meth)acrylate; lauryl (meth)acrylate; cyclohexyl (meth)acrylate; 3,3,5-trimethylcyclohexyl (meth)acrylate; 4-tert-butyl cyclohexyl (meth)acrylate; isobornyl (meth)acrylate; norbornyl (meth)acrylate; dihydrodicyclopentandienyl (meth)acrylate; ethylene glycol monomethyl ether (meth)acrylate; ethylene glycol monoethyl ether (meth)acrylate; ethylene glycol monododecyl ether (meth)acrylate; diethylene glycol monomethyl ether (meth)acrylate; trifluoroethyl (meth)acrylate; and, perfluorooctyl (meth)acrylate.

The presence of aromatic (meth)acrylate monomers in the complete monomer mixture is not precluded and, as such, the complete monomer mixture may comprise at least one ethylenically unsaturated functional monomer represented by Formula MA2:

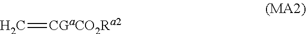

wherein: G^{a} is hydrogen, halogen or methyl; and,
   R^{a2} is C₆-C₁₈ aryl, C₁-C₉ heteroaryl, C₇-C₁₈ alkoxyaryl, C₇-C₁₈ alkaryl or C₇-C₁₈ aralkyl.

And exemplary (meth)acrylate monomers in accordance with Formula MA2—which may be used alone or in combination—include but are not limited to: benzyl (meth)acrylate; phenoxyethyl (meth)acrylate; and, phenoxypropyl (meth)acrylate.

Monomers of Formula MA2 may, in exemplary embodiments, contribute from about 0 to about 20 wt. % or from about 0 to about 10 wt. % of the total weight of monomers of Formula MA in the complete monomer mixture. In various non-limiting embodiments, all values and ranges of values, both whole and fractional, including and between those set forth above are expressly contemplated for use herein.

### Monomer Component ii): Vinyl Aromatic Monomers

The complete monomer mixture of which the core-shell latex copolymer is a reaction product may optionally comprise at least one vinyl aromatic monomer. Monomer component ii) may account for from about 0 to about 50 wt. %, for instance from about 0 to about 30 wt. %, from about 0 to about 20 wt. % or from about 0 to about 10 wt. % based on the total weight of monomer residues in the core-shell latex copolymer. In various non-limiting embodiments, all values and ranges of values, both whole and fractional, including and between those set forth above are expressly contemplated for use herein.

Suitable vinyl aromatic monomers include, in particular, those represented by Formula (VA):

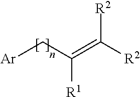

wherein: R¹ is H or C₁-C₄ alkyl;
   each R² is independently hydrogen or C₁-C₄ alkyl;
   Ar is unsubstituted phenyl or phenyl substituted with from 1 to 5 substituents, wherein each substituent is independently halogen or C₁-C₄ alkyl; and,
   n is an integer from 0 to 4.

Typical monomers in accordance with Formula VA are those wherein: R¹ is H or methyl; each R² is independently H or methyl; Ar is unsubstituted phenyl or phenyl substituted with from 1 to 5 substituents, wherein each substituent is independently halogen or C₁-C₄ alkyl; and, n is 0 or 1. Further, exemplary vinyl aromatic monomers in accordance with Formula (VA)—which may be used alone or in combination—include but are not limited to: styrene; α-methylstyrene; 2-methylstyrene; 3-methylstyrene; 4-methylstyrene; 2-tert-butyl styrene; 4-tert-butylstyrene; 2-chlorostyrene; and, 4-chlorostyrene.

Monomer Component iii) Multifunctional Ethylenically Unsaturated Monomers

In certain embodiments, the core-shell latex copolymer will comprise the residue of at least one monomer having at least two ethylenically unsaturated groups and having a weight average molecular weight (Mw) of at most 600 Daltons.

When such a monomer is present, the core and/or the shell copolymer will include a partially or substantially-crosslinked network. The amount of such monomers should be selected such that the degree of cross-linking does not overly inhibit the ability of the core-shell latex copolymer to swell. For example, monomer component iii) may account for from about 0 to about 5 wt. %, for instance from about 0.1 to about 2.5 wt. % or from about 0.5 to 2.5 wt. %, based on the total weight of monomer residues in the core-shell latex copolymer. In various non-limiting embodiments, all values and ranges of values, both whole and fractional, including and between those set forth above are expressly contemplated for use herein.

It is typical herein that from about 70 to about 100 wt. %, for instance from about 80 to about 100 wt. % or from about 90 to about 100 wt. % of the total weight of monomers of component iii) be present in the monomer mixture of which the shell copolymer is a reaction product. In various non-limiting embodiments, all values and ranges of values, both whole and fractional, including and between those set forth above are expressly contemplated for use herein.

Exemplary monomers of component iii), which may be used alone or in combination, include: conjugated dienes, such as butadiene and isoprene; allyl compounds, including such as allyl (meth)acrylate, diallyl phthalate, diallyl itaconate, diallyl fumarate and diallyl maleate; polyallyl ethers of polyols, including polyallyl ethers of trimethylolpropane, pentaerythritol and sucrose; poly(meth)acrylates of alkane polyols; poly(meth)acrylates of oxyalkane polyols; and, poly(C₂-C₄)alkylene glycol di(meth)acrylates. For instance, compounds having utility herein, either alone or in combination, include: 1,2-ethanediol dimethacrylate; 1,2-propanediol di(meth)acrylate; 1,3-propanediol di(meth)acrylate; 1,3-butanediol di(meth)acrylate; 1,4-butanediol di(meth)acrylate; 2,2-dimethylpropane-1,3-diol di(meth)acrylate; 1,6-hexanediol di(meth)acrylate; 3-methyl-1,5-pentanediol di(meth)acrylate; 1,10-decanediol diacrylate; and, tricyclodecanedimethanol di(meth)acrylate.

Further exemplary compounds having two (meth)acrylate groups include compounds in accordance with Formula DA1:

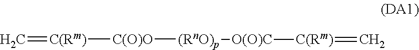

wherein: each R^{m} is independently H or CH₃;
   each Rⁿ is independently C₂-C₄ alkylene; and,
   p is an integer of from 1 to 8.

It is preferred that: each R^{m} is independently H or CH₃, preferably H; each Rⁿ is independently ethylene or propylene; and, p is an integer of from 1 to 5 or from 2 to 4.

Exemplary compounds in accordance with Formula DA1, which may be used alone or in combination, include but are not limited to: tetraethylene glycol di(meth)acrylate; triethylene glycol di(meth)acrylate; tripropylene glycol di(meth)acrylate; and, dipropylene glycol di(meth)acrylate.

Tri(meth)acrylate compounds having utility in monomer component iii) include the tri(meth)acrylates of trihydric polyols. The tri(meth)acrylates of alkoxylated trihydric polyols may be used, in particular the tri(meth)acrylates of ethoxylated, propoxylated and/or butoxylated trihydric polyols. Exemplary trifunctional (meth)acrylate compounds included but are not limited to: trimethylolpropane tri(meth)acrylate; pentaerythritol tri(meth)acrylate; ethoxylated trimethylolpropane tri(meth)acrylate; propoxylated trimethylolpropane tri(meth)acrylate; ethoxylated trimethylolpropane tri(meth)acrylate; and, propoxylated glyceryl tri(meth)acrylate. In certain embodiments, trimethylolpropane triacrylate (TMPTA) and/or pentaerythritol triacrylate (PETIA) may be used.

Further (meth)acrylate compounds having utility in monomer component iii) include but are not limited to: di(trimethylolpropane) tetracrylate; pentaerythritol tetracrylate; and, di-trimethylolpropane tetraacrylate (Di-TMPTTA); and, dipentaerythritol pentaacrylate (Di-PEPA).

### Monomer Component iv): Hydroxyl Functional Ethylenically Unsaturated Monomer

The complete monomer mixture of which the core-shell latex copolymer is a reaction product may optionally comprise iv) at least one hydroxyl functional ethylenically unsaturated monomer. Monomer component iv) may account for from about 0 to about 15 wt. %, for instance from about 0 to about 10 wt. % or from about 1 to about 5 wt. % based on the total weight of monomer residues in the core-shell latex copolymer. In various non-limiting embodiments, all values and ranges of values, both whole and fractional, including and between those set forth above are expressly contemplated for use herein.

A hydroxyl functional ethylenically unsaturated monomer may be present: in the monomer mixture of which the core copolymer is a reaction product; in the monomer mixture of which the shell copolymer is a reaction product; or, in both of said monomer mixtures. In certain embodiments, the core copolymer comprises from about 70 to about 100 wt. %, for instance from about 80 to about 100 wt. % or from about 90 to about 100 wt. % of the total weight of monomer residues of iv) said hydroxyl functional unsaturated monomers in the core-shell copolymer. In various non-limiting embodiments, all values and ranges of values, both whole and fractional, including and between those set forth above are expressly contemplated for use herein.

Suitable hydroxyl functional ethylenically unsaturated monomers which may be utilized in the synthesis of core-shell latex copolymer include hydroxyalkyl esters with primary or secondary hydroxyl groups derived from α,β-monoethylenically unsaturated monocarboxylic acids. These can include, for instance, hydroxyalkyl esters derived from acrylic acid, methacrylic acid, crotonic acid or iso-crotonic acid.

In certain embodiments, the complete monomer mixture may comprise at least one hydroxyl (meth)acrylate monomer represented by Formula HMA:

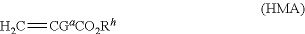

wherein: G^{a} is hydrogen, halogen or methyl; and,
   R^{h} is C₁-C₁₈ hydroxyalkyl.

Typical monomers in accordance with Formula HMA are those wherein: G^{a} is hydrogen, halogen or methyl; and, R^{h} is C₁-C₁₂ hydroxyalkyl. Monomers in which G^{a} is hydrogen or methyl and R^{h} is C₁-C₆ hydroxyalkyl may also be used.

Examples of (meth)acrylate monomers in accordance with Formula HMA include but are not limited to: hydroxyethyl (meth)acrylate; 1-hydroxypropyl (meth)acrylate; 2-hydroxypropyl (meth)acrylate; 1-hydroxybutyl (meth)acrylate; 2-hydroxybutyl (meth)acrylate; and, 3-hydroxybutyl (meth)acrylate.

In an embodiment, the complete monomer mixture may comprise at least one hydroxyl functional adduct of a monoepoxyester and an unsaturated carboxylic acid. Under catalysis, nucleophilic addition reaction of the monoepoxyester with the acid occurs to form a hydroxyalkyl ester, which ester product is subsequently included in the monomer mixture to be polymerized. This acidolysis ring-opening reaction conventionally requires a catalysts, of which tertiary amines, quaternary ammonium compounds and transition metals compounds may be mentioned as examples.

The reactant monoepoxyesters are typically glycidyl esters derived from aliphatic saturated monocarboxylic acids having a tertiary or quaternary carbon atom in the alpha (α-) position. Representative reactant monoepoxyesters are the glycidyl esters of saturated α,α-dialkylalkane-monocarboxylic acids having from 5 to 13 carbons atoms or from 9 to 11 carbon atoms in the acid molecule. Exemplary reactant monoepoxyesters include: versatic acid glycidylester available commercially as Cardura E10 from Hexion; pivalic acid glycidylester, available commercially as Cardura E5 from Hexion; and, the reaction product of a tertiary fatty acid up to 12 carbon atoms and epichlorohydrin.

The reactant acid functional compound can be aliphatic unsaturated monocarboxylic acids, of which non-limiting examples include: α,β-monoethylenically unsaturated monocarboxylic acids, such as acrylic acid, methacrylic acid, crotonic acid, itaconic acid and isocrotonic acid; C₁-C₆ alkyl half-esters of α,β-monoethylenically unsaturated dicarboxylic acids, such as fumaric acid and maleic acid; and, C₁-C₆ alkyl esters of α,β-monoethylenically unsaturated tricarboxylic acids bearing one free carboxylic acid group. In various embodiments, acrylic acid and/or methacrylic acid as the reactant acid functional compound.

### Monomer Component v): Carbonyl Functional Ethylenically Unsaturated Monomers

The complete monomer mixture of which the core-shell latex copolymer is a reaction product comprises v) at least one carbonyl functional ethylenically unsaturated monomer. Monomer component v) may account for from about 1 to about 15 wt. %, for instance from about 1 to about 10 wt. % or from about 1 to about 5 wt. % based on the total weight of monomer residues in the core-shell latex copolymer. In various non-limiting embodiments, all values and ranges of values, both whole and fractional, including and between those set forth above are expressly contemplated for use herein.

As noted above, at least one of the monomer mixture of which the core copolymer is a reaction product and the monomer mixture of which the shell copolymer is a reaction product comprises v) said at least one carbonyl functional ethylenically unsaturated monomer. Thus a carbonyl functional ethylenically unsaturated monomer may be present: in the monomer mixture of which the core copolymer is a reaction product; in the monomer mixture of which the shell copolymer is a reaction product; or, in both of said monomer mixtures. It is typical herein that from about 70 to about 100 wt. %, for instance from about 80 to about 100 wt. % or from about 90 to about 100 wt. % of the total weight of monomers of component v) be present in the monomer mixture of which the shell copolymer is a reaction product. In various non-limiting embodiments, all values and ranges of values, both whole and fractional, including and between those set forth above are expressly contemplated for use herein.

Exemplary carbonyl functional ethylenically unsaturated monomers which may have utility herein, either alone or in combination, include: acrolein; methacrolein; 4-vinyl-benzaldehyde (p-formylstyrene); diacetone acrylamide; diacetone methacrylamide; diacetone acrylate; diacetone methacrylate; allyl acetoacetate; vinyl acetoacetate; vinyl acetoacetamide; acetoacetoxy(C₁-C₆)alkyl (meth)acrylates, such as acetoacetoxymethyl (meth)acrylate, 2-(acetoacetoxy)ethyl (meth)acrylate, 2-acetoacetoxypropyl (meth)acrylate; butanediol-1,4-acrylate-acetylacetate; and, vinyl (C₁-C₆)alkyl ketones, such as vinyl methyl ketone, vinyl ethyl ketone and vinyl isobutyl ketone. Diacetone acrylamide may be used in certain embodiments.

### Monomer Component vi): Monomers of Formula U1 and Formula CU1

The complete monomer mixture of which the core-shell latex copolymer is a reaction product may optionally comprise vi) at least one monomer chosen from monomers of Formula U1, Formula CU1 and mixtures thereof:

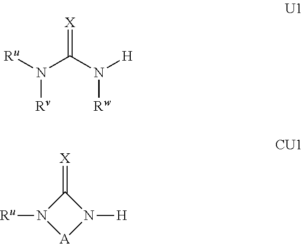

wherein: X is O or S;
   A is C₂-C₃ alkylene;
   R^{u} is a group of the formula -(Alk-L)_{y}-R^{x};
   R^{v} and R^{w} are independently H or C₁-C₈ alkyl;
   y is 0 or 1;
   Alk is C₂-C₈ alkylene;
   L is —O— or —NR^{z}—, wherein R^{z} is H or C₁-C₈ alkyl;
   R^{x} is 2-(2-carboxyacrylamide)ethyl, vinyl, allyl group, isopropenyl, acryloyl, methacryloyl or 2-hydroxy-3-(allyloxy)propyl.

Monomer component vi) may account for from about 0 to about 15 wt. %, for instance from about 1 to about 10 wt. % or from about 1 to about 5 wt. % based on the total weight of monomer residues in the core-shell latex copolymer. In various non-limiting embodiments, all values and ranges of values, both whole and fractional, including and between those set forth above are expressly contemplated for use herein.

Monomers in accordance with Formula U1 or, independently, in accordance with Formula CU1 may be present: in the monomer mixture of which the core copolymer is a reaction product; in the monomer mixture of which the shell copolymer is a reaction product; or, in both of said monomer mixtures. Typically herein from about 50 to about 90 wt. %, for instance from about 55 to about 85 wt. % or from about 60 to about 80 wt. % of the total weight of monomers of component vi) are present in the monomer mixture of which the shell copolymer is a reaction product. In various non-limiting embodiments, all values and ranges of values, both whole and fractional, including and between those set forth above are expressly contemplated for use herein.

Typical monomers of Formula U1 and Formula CU1 are those wherein: X is O; A is C₂ alkylene; and, Alk is C₂-C₆ alkylene. Exemplary monomers according to Formula CU1, which may be copolymerized alone or in combination include: N-(meth)acryoyl urea; N-vinylethyleneurea; N-vinyloxyethylethyleneurea; N-(2-acryloyloxyethyl)ethylene urea; N-(2-methacryloyloxyethyl)ethylene urea; N-(acrylamidomethyl)ethylene urea; and, N-(2-methacrylamidoethyl)ethylene urea (MAEEU). The lattermost monomer is commercially available as Sipomer® WAM II from Solvay.

Monomer Component vii): Ethylenically Unsaturated Acid Functional Monomer

The complete monomer mixture of which the core-shell latex copolymer is a reaction product may optionally comprise vii) at least one ethylenically unsaturated acid functional monomer. Monomer component vii) may account for about 0.1 to about 15 wt. %, for instance from about 0.5 to about 15 wt. %, from about 0.5 to about 10 wt. % or from about 1 to about 5 wt. % based on the total weight of monomer residues in the core-shell latex copolymer. In various non-limiting embodiments, all values and ranges of values, both whole and fractional, including and between those set forth above are expressly contemplated for use herein.

As used herein, the term “ethylenically unsaturated acid functional monomer” denotes an ethylenically unsaturated monomer which is capable of developing a negative charge (—CO₂⁻) when the monomer is in an aqueous solution, and which anionic monomer is not an associative monomer, as defined below.

The ethylenically unsaturated acid functional monomer may be chosen from: ethylenically unsaturated carboxylic acids; ethylenically unsaturated sulfonic acids; ethylenically unsaturated phosphonic acids; and, mixtures thereof. Suitable ethylenically unsaturated sulfonic acids are, for instance, vinylsulfonic acid, methallyl sulfonic acid, allyloxybenzene sulfonic acid, styrenesulfonic acid, 2-acrylamido-2-methylpropanesulfonic acid, 2-methyacrylamido-2-methylpropanesulfonic acid, 2-acrylamidobutanesulfonic acid, 3-acrylamidobutanesulfonic acid and 2-acrylamido-2,4,4-trimethylpentanesulfonic acid. Suitable ethylenically unsaturated phosphonic acids include, for instance, vinylphosphonic acid, allylphosphonic acid, N-(meth)acrylamidoalkylphospohonic acid and (meth)acryloyloxyalkylphosphonic acids.

Exemplary ethylenically unsaturated carboxylic acids may be chosen from: α,β-monoethylenically unsaturated monocarboxylic acids; α,β-monoethylenically unsaturated dicarboxylic acids; C₁-C₆ alkyl half-esters of α,β-monoethylenically unsaturated dicarboxylic acids; α,β-monoethylenically unsaturated tricarboxylic acids; and, C₁-C₆ alkyl esters of α,β-monoethylenically unsaturated tricarboxylic acids bearing at least one free carboxylic acid group; and, mixtures thereof. In certain embodiments, the ethylenically unsaturated carboxylic acids may be chosen from: methacrylic acid; acrylic acid; 2-ethylacrylic acid; α-chloro-acrylic acid; α-cyano acrylic acid; α-phenyl acrylic acid; itaconic acid; maleic acid; aconitic acid; crotonic acid; fumaric acid; cinnamic acid; p-chloro cinnamic acid; and, mixtures thereof.

In an embodiment, the amount of strong acid monomers in the complete monomer mixture may be limited. The complete monomer mixture may be exemplified by comprising, based on the total weight of monomer residues in the core-shell latex copolymer, less than about 0.5 wt. %, for instance less than 0.3 wt. %, less than 0.2 wt. % or less than 0.1 wt. % of ethylenically unsaturated acid functional monomers having a pKa of less than 4 as determined in water at 20° C.

For completeness, whilst such acid monomers should typically be used in the form of free acid, it is not precluded that the constituent acid groups of the monomers be partially or completely neutralized with suitable bases, provided this does not compromise their participation in copolymerization. Suitable counterions for the acidic group include ammonium ions (NH₄⁺); quaternary amines; alkali metal cations, in particular Li⁺, Na⁺ and K⁺; and, alkaline earth metal cations.

Monomer Component viii)

The incorporation of certain additional functionalities into (meth)acrylate monomers can improve the surface adhesion of copolymers derived therefrom. Thus, in an embodiment, the core-shell latex copolymer further comprises residues of: viii) at least one (meth)acrylate monomer having anhydride, phosphate or phosphonate functionality. For example, monomer component viii) may, for instance, account for from about 0 to about 10 wt. %, for instance from about 1 to about 5 wt. %, based on the total weight of monomer residues in the core-shell latex copolymer. In various non-limiting embodiments, all values and ranges of values, both whole and fractional, including and between those set forth above are expressly contemplated for use herein.

Exemplary phosphate or phosphonate functional monomers include: 2-monomethacryloxyethyl phosphate; bis(2-methacryloxyethyl) phosphate; 2-acryloyloxyethyl phosphate; bis-(2-acryloyloxyethyl) phosphate; methyl-(2-methacryloyloxyethyl) phosphate; ethyl methacryloyloxyethyl phosphate; methyl acryloyloxyethyl phosphate; ethyl acryloyloxyethyl phosphate; 2-hydroxyethylmethacrylate phosphate; and, 10-[(2-methylprop-2-enoyl)oxy]decyl dihydrogen phosphate (10-methacryloyloxydecyl dihydrogen phosphate). 4-methacryloxyethyl trimellitic anhydride may also be used.

### Monomer Component ix): Ethylenically Unsaturated Associative Monomers

Optionally, the core-shell latex copolymer may further comprise residues of: ix) at least one ethylenically unsaturated associative monomers. Monomer component ix) may account for from about 0 to about 10 wt. %, for instance from about 0 to about 5 wt. %, based on the total weight of monomer residues in the core-shell latex copolymer. In various non-limiting embodiments, all values and ranges of values, both whole and fractional, including and between those set forth above are expressly contemplated for use herein.

The term “ethylenically unsaturated associative monomer” as used herein denotes an ethylenically unsaturated monomer having a hydrophilic segment and a terminal hydrophobe functionality. The hydrophilic segments function as a spacer moiety: when associative monomers are polymerized in aqueous media, the spacer disposes the hydrophobe functionality sufficiently far away from the backbone of the polymer to permit hydrophobic associations. The spacer moieties usually but not necessarily include C₂-C₄ alkoxyate groups, of which ethoxylate (EO), propoxylate (PO) and butoxylate (BO) groups may be mentioned as examples.

Exemplary ethylenically unsaturated associative monomers, which may be used herein alone or in combination, include those having the general formula AM1:

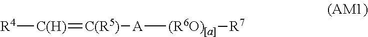

wherein: R⁴ is H, methyl, CO₂H or CH₂CO₂H;
   R⁵ is hydrogen, halogen or methyl;
   A is —CH₂C(O)O—, —C(O)O—, —O—, —CH₂O—, —CH₂C(O)N—, —C(O)N—, —CH₂—, —O—C(O)—, —HC(O)O—, —NHC(O) NH—, —C₆H₄ (R⁸)—NH—C(O)—O—, —C₆H₄ (R⁸)—NH—C(O)—NH—;
   each R⁶ is independently C₂-C₄ alkylene;
   [a] has a value of from 5 to 100;
   R⁷ is C₁-C₃₀ alkyl, C₃-C₁₈ cycloalkyl, C₂-C₅heterocycloalkyl, C₂-C₂₀ alkenyl, C₂-C₁₂ alkynyl, C₆-C₁₈ aryl, C₇-C₂₄ alkaryl or C₇-C₂₄ aralkyl; and,
   R⁸ is —CH₂— or —(C)(CH₃)₂—.

According to general formula AM1, the moiety-(R⁶O)ₐ represents a polyoxyalkylene which may be a homopolymer, random copolymer or block copolymer of C₂-C₄ oxyalkylene units.

Typical monomers in accordance with Formula AM1: R⁴ is H, methyl, CO₂H or CH₂CO₂H; R⁵ is hydrogen, halogen or methyl; A is —CH₂C(O)O— or —C(O)O—; each R⁶ is independently C₂-C₄ alkylene; [a] has a value of from 10 to 30; and, R⁷ is C₆-C₃₀ alkyl, C₃-C₁₈ cycloalkyl, C₆-C₁₈ aryl, C₇-C₁₈ alkaryl or C₇-C₁₈ aralkyl.

Representative monomers in accordance with Formula AM1 are those wherein: R⁴ is H, methyl, CO₂H or CH₂CO₂H; R⁵ is hydrogen, halogen or methyl; A is —C(O)O—; each R⁶ is independently C₂-C₃ alkylene; [a] has a value of from 10 to 30; and, R⁷ is C₆-C₃₀ alkyl.

Exemplary monomers in accordance with Formula AM1, which may be copolymerized alone or in combination, include: lauryl ethoxylate [a] (meth)acrylate; cetyl ethoxylate [a] (meth)acrylate; stearyl ethoxylate [a] (meth)acrylate; behenyl ethoxylate [a] (meth)acrylate; lauryl ethoxylate [a] itaconate; cetyl ethoxylate [a] itaconate; stearyl ethoxylate [a] itaconate; behenyl ethoxylate [a] itaconate; lauryl ethoxylate [a] maleate; cetyl ethoxylate [a] maleate; stearyl ethoxylate [a] maleate; and, behenyl ethoxylate [a] maleate, wherein [a] represents the number of moles of ethoxylation and has a value of from 10 to 30. In other words, each of the above may be described as an ethoxylated compound that has a degree of ethoxylation of from 10 to 30 moles of ethylene oxide. The parameter [a] may, in certain embodiments, have a value of from 15 to 30 or from 15 to 25. In various non-limiting embodiments, all values and ranges of values, both whole and fractional, including and between those set forth above are expressly contemplated for use herein.

### Monomer Component x): Optional Further Monomers

The core-shell latex copolymer may further comprise residues of ethylenically unsaturated monomers not mentioned above. Exemplary further monomers include: (meth)acrylate functionalized oligomers; nitrogen (N—) functionalized ethylenically unsaturated monomers other than monomers of Formula U1 and CU1 above; silane-functional ethylenically unsaturated monomers, such as methacryloxypropyl tri(C₁-C₅)alkoxysilanes and vinyl tri(C₁-C₅)alkoxysilanes; acetoacetyl-functional unsaturated monomers, such as acetoacetoxy ethylmethacrylate; alkenes such as ethylene and propylene; naphthalene based monomers, such as 1-allyl naphthalene, 2-allyl naphthalene, 1-vinyl naphthalene and 2-vinyl naphthalene; vinyl esters; vinyl and vinylidene halides; vinyl ethers; alkyl vinyl ketones; cycloalkyl vinyl ketones; divinyl glycol; divinyl benzene; heterocyclic aliphatic vinyl compounds; and, reactive surfactants exemplified by the inclusion of (meth)acryl-, allyl-, vinyl- and styryl-groups in the surfactant molecule and of which examples include allyloxy nonylphenol polyoxyethylene ether sulfate, polyoxyethylene styrenated phenyl ether ammonium sulfate, sulfonated 3-pentadecyl phenyl acrylate and vinylbenylsulfosuccinic acid.

Suitable (meth)acrylate functionalized oligomers may be chosen from (meth)acrylate-functionalized polyurethanes, (meth)acrylate-functionalized polybutadienes, (meth)acrylic polyol (meth)acrylates, polyester (meth)acrylate oligomers, polyamide (meth)acrylate oligomers, polyether (meth)acrylate oligomers and mixtures thereof. Said oligomers may have one or more acrylate and/or methacrylate groups attached to the oligomeric backbone, which (meth)acrylate functional groups may be in a terminal position on the oligomer and/or may be distributed along the oligomeric backbone. In certain embodiments, the or each (meth)acrylate functionalized oligomer reacted as a monomer in deriving the core-shell latex copolymer: has two or more (meth)acrylate functional groups per molecule; and/or, has a weight average molecular weight (Mw) of from 300 to 1000 Daltons.

With regard to (N—) functionalized ethylenically unsaturated monomers other than monomers of Formula U1 or CU1 above, the nitrogen functionalized groups may either be nitrile, urea or thiourea or may possess imidic, amidic or aminic nitrogen atoms.

Exemplary nitrile monomers include but are not limited to acrylonitrile and methacrylonitrile. Exemplary maleimide monomers include but are not limited to: maleimide; methylmaleimide; ethylmaleimide; propylmaleimide; butylmaleimide; hexylmaleimide; octylmaleimide; dodecylmaleimide; stearylmaleimide; phenylmaleimide; and, cyclohexylmaleimide. And exemplary (meth)acrylamides include but are not limited to: acryloyl morpholine; diacetone (meth)acrylamide; N-methyl (meth)acrylamide; N-ethyl (meth)acrylamide; N-isopropyl (meth)acrylamide; N-t.butyl (meth)acrylamide; N-hexyl (meth)acrylamide; N-cyclohexyl (meth)acrylamide; N-octyl (meth)acrylamide; N-t.octyl (meth)acrylamide; N-dodecyl (meth)acrylamide; N-benzyl (meth)acrylamide; N-(hydroxymethyl)acrylamide; N-isobutoxymethyl acrylamide; N-butoxymethyl acrylamide; N,N-dimethyl (meth)acrylamide; N,N-diethyl (meth)acrylamide; N,N-propyl (meth)acrylamide; N,N-dibutyl (meth)acrylamide; N,N-dihexyl (meth)acrylamide; N,N-dimethylamino methyl acrylamide; N,N-dimethylamino ethyl acrylamide; N,N-dimethylamino propyl acrylamide; N,N-dimethylamino hexyl acrylamide; N,N-diethylamino methyl acrylamide; N,N-diethylamino ethyl acrylamide; N,N-diethylamino propyl acrylamide; N,N-dimethylamino hexyl acrylamide; N-hydroxymethyl (meth)acrylamide; acrylamido-2-methylpropanesulfonate; and, N,N′-methylenebisacrylamide.

The inclusion in the core-shell latex copolymer a1) of the residue(s) of at least one amino (meth)acrylate monomer is not precluded. As used herein, the term “amino (meth)acrylate” refers to a derivative of methacrylic acid or acrylic acid that has a primary, secondary, or tertiary amino group: the amino group can be part of a linear, branched or cyclic aliphatic group or an aromatic group. Desirably, said at least one amino (meth)acrylate monomer should be a tertiary amino (meth)acrylate, such as, in particular, an N,N-dialkylaminoalkyl (meth)acrylate. As exemplary monomers there may be mentioned: N,N-dimethylaminoethylmethacrylate; N,N-dimethylaminoethylacrylate; N,N-dimethylaminopropylmethacrylate; and, N,N-dimethylaminopropylacrylate.

In a further embodiment, which is not intended to be mutually exclusive of the embodiments above, the core-shell latex copolymer may further comprise residue(s) of at least one vinyl monomer having a nitrogen heterocyclic structure. Exemplary heterocyclic structures have either 5- or 6-members and may comprise oxygen atoms in addition to nitrogen: the 5- or 6-membered ring may, for instance, represent a pyridine, pyrimidine, pyridazine, imidazoline, imidazole, oxazoline, oxazole or morpholine ring. And examples thereof, which may be used alone or in combination, include: N-vinylcaprolactam (NVC); vinyl methyl oxazolidinone (VMOX); N-vinylformamide; N-vinylcarbazole; N-vinylacetamide; and, N-vinylpyrrolidone.

Exemplary vinyl esters which may be copolymerized in the present disclosure include vinyl acetate, vinyl propionate, vinyl butyrate, vinyl caprolate, vinyl valerate, vinyl hexanoate, vinyl decanoate, vinyl 2,2,3,5-tetramethylhexanoate, vinyl 2,4-dimethyl-2-isopropylpentanoate, vinyl 2,5-dimethyl-2-ethylhexanoate, vinyl 2,2-dimethyloctanoate, vinyl 2,2-diethylhexanoate, vinyl laurate, vinyl pivalate, vinyl benzoate, vinyl cinnamate and monomers of the VEOVA™ series available from Hexion.

As noted above, the keto-functional core-shell latex copolymers according to the present disclosure comprise at least two copolymers and are synthesized in sequential stages via free radical emulsion copolymerization.

Without intention to limit the present disclosure, conventional polymerization conditions will include a temperature in the range of from about 25 to about 100° C., for example from about 50 to about 100° C. or from about 75 to about 100° C. In various non-limiting embodiments, all values and ranges of values, both whole and fractional, including and between those set forth above are expressly contemplated for use herein.

The polymerization pressure is generally not critical and, as such, the stages of polymerization may be conducted at sub-atmospheric, atmospheric or super-atmospheric pressure. Pressure aside, the stages of polymerization may be conducted, where necessary, under the exclusion of oxygen: the reaction vessel may be provided with an inert, dry gaseous blanket of, for example, nitrogen, helium and argon.

Herein free radical polymerization will be triggered by means of at least one radical generating initiator. The polymerization composition should conventionally comprise from about 0.1 to about 2 wt. %, for example from about 0.1 to about 1 wt. %, from about 0.1 to about 0.8 wt. % or about 0.1 to about 0.5 wt. % of the at least one radical generating initiator, based on the total weight of the polymerizable monomers. In various non-limiting embodiments, all values and ranges of values, both whole and fractional, including and between those set forth above are expressly contemplated for use herein.

A first exemplary class of radical generating initiators include inorganic peroxides such as: peroxydisulphates, particularly the ammonium or alkali metal salts thereof; perborate tetrahydrates, particularly the ammonium or alkali metal salts thereof; carbonate peroxyhydrates, particularly the ammonium or alkali metal salts thereof. A further exemplary class of radical generating initiators suitable for use herein are organic peroxides, chosen for example from: cyclic peroxides; diacyl peroxides; dialkyl hydroperoxides; peroxycarbonates; peroxydicarbonates; peroxyesters; peroxyketals; and, mixtures thereof.

While certain peroxides—such as dialkyl peroxides—may have utility herein, hydroperoxides represent a useful class of initiator for the present disclosure. Further, whilst hydrogen peroxide itself may be used, more desirable polymerization initiators are the organic hydroperoxides. For completeness, included within the definition of hydroperoxides are materials such as organic peroxides or organic peresters which decompose or hydrolyze to form organic hydroperoxides in situ: examples of such peroxides and peresters are cyclohexyl and hydroxycyclohexyl peroxide and t-butyl perbenzoate, respectively.

In an embodiment of the disclosure, the radical generating initiator comprises at least one hydroperoxide compound represented by the formula:

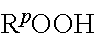

wherein: R^{p} is an aliphatic or aromatic group containing up to 18 carbon atoms. In an embodiment, R^{p} is C₁-C₁₂ alkyl, C₆-C₁₈ aryl or C₇-C₁₈ aralkyl.

As exemplary peroxide initiators, which may be used alone or in combination, there may be mentioned: cumene hydroperoxide (CHP); para-menthane hydroperoxide; t-butyl hydroperoxide (TBH); t-butyl perbenzoate; t-butyl peroxy pivalate; di-t-butyl peroxide; t-butyl peroxy acetate; t-butyl peroxy-2-hexanoate; t-amyl hydroperoxide; 1,2,3,4-tetramethylbutyl hydroperoxide; benzoyl peroxide; dibenzoyl peroxide; 1,3-bis(t-butylperoxyisopropyl)benzene; diacetyl peroxide; butyl 4,4-bis(t-butylperoxy) valerate; p-chlorobenzoyl peroxide; t-butyl cumyl peroxide; di-t-butyl peroxide; dicumyl peroxide; 2,5-dimethyl-2,5-di-t-butylperoxyhexane; 2,5-dimethyl-2,5-di-t-butyl-peroxyhex-3-yne; and, 4-methyl-2,2-di-t-butylperoxypentane.

A further exemplary class of radical generating initiators suitable for use herein are azo polymerization initiators, chosen for example from: azo nitriles; azo esters; azo amides; azo amidines; azo imidazoline; macro azo initiators; and, mixtures thereof.

As representative examples of suitable azo polymerization initiators there may be mentioned: 2,2′-azobis(2-methylbutyronitrile); 2,2′-azobis(isobutyronitrile); 2,2′-azobis(2,4-dimethylvaleronitrile); 2,2′-azobis(4-methoxy-2,4-dimethylvaleronitrile); 1,1′-azobis(cyclohexane-1-carbonitrile); 4,4′-azobis(4-cyanovaleric acid); dimethyl 2,2′-azobis(2-methylpropionate); 2,2′-azobis[2-methyl-N-(2-hydroxyethyl) propionamide]; 2,2′-azobis(N-butyl-2-methylpropionamide); 2,2′-azobis[2-(2-imidazolin-2-yl)propane]dihydrochloride; 2,2′-azobis[2-(2-imidazolin-2-yl)propane]; 2,2′-azobis(2-methylpropionamidine) dihydrochloride; 2,2′-azobis[N-(2-carboxyethyl)-2-methylpropionamidine]tetrahydrate; 4,4-azobis(4-cyanovaleric acid), polymer with alpha, omega-bis(3-aminopropyl) polydimethylsiloxane (VPS-1001, available from Wako Pure Chemical Industries, Ltd.); and, 4,4′-azobis(4-cyanopentanoicacic) polyethyleneglycol polymer (VPE-0201, available from Wako Pure Chemical Industries, Ltd.).

Redox initiators are a combination of an oxidizing agent and a reducing agent and may also have utility in the present disclosure. Suitable oxidizing agents may be chosen from cyclic peroxides, diacyl peroxides, dialkyl peroxides, hydroperoxides, peroxycarbonates, peroxydicarbonates, peroxyesters, peroxyketals and mixtures thereof. The corresponding reducing agent may be chosen from: alkali metal sulfites; alkali metal hydrogensulfites; alkali metal metabisulfites; formaldehyde sulfoxylates; alkali metal salts of aliphatic sulfinic acids; alkali metal hydrogensulfides; salts of polyvalent metals, in particular Co(II) salts and Fe(II) salts such iron(II) sulfate, iron(II) ammonium sulfate or iron(II) phosphate; dihydroxymaleic acid; benzoin; ascorbic acid; reducing saccharides, such as sorbose, glucose, fructose and/or dihydroxyacetone; and, mixtures thereof.

Aside from initiators, it is considered that the free radical emulsion polymerization may be conducted in the presence of chain transfer agents which act to transfer free radicals and which reduce the molecular weight of the obtained copolymer and/or control chain growth in the polymerization. When added, the chain transfer agent should constitute from about 0.01 to about 1 wt. %, based on the total weight of polymerizable monomers. The amount of polymerization initiator and any chain transfer agents present may be determinative of the number average molecular weight of the copolymers, although the choice of solvent may also be important.

The emulsion polymerization reactions are performed in an aqueous medium. The concentration of the monomers in the emulsion may vary but it will be typical for the ratio by weight of monomers to water to be in the range from about 1:20 to about 2:1, for example from about 1:5 to about 2:1 or from about 1:2 to about 1.5:1. In various non-limiting embodiments, all values and ranges of values, both whole and fractional, including and between those set forth above are expressly contemplated for use herein.

Whilst the diluent of the aqueous medium may consist of water, it is not precluded that the aqueous medium further comprises one or more polar co-solvents. When present, such polar co-solvents should have a boiling point of at least about 20° C., for instance at least about 30° C. or at least about 40° C., as measured at 1 atmosphere pressure (1.01325 Bar). Examples of such polar co-solvents, which may be used alone or in combination, include but are not limited to: C₁-C₈ alkanols, such as methanol, ethanol, n-propanol, isopropanol, n-butanol, sec-butanol and isobutanol; acetonitrile; N,N-di(C₁-C₄)alkylacylamides, such as N,N-dimethylformamide (DMF) and N,N-dimethylacetamide (DMAc); hexamethylphosphoramide; N-methylpyrrolidone; pyridine; esters, such as (C₁-C₈)alkyl acetates, ethoxydiglycol acetate, dimethyl glutarate, dimethyl maleate, dipropyl oxalate, ethyl lactate, benzyl benzoate, butyloctyl benzoate and ethylhexyl benzoate; ketones, such as acetone, ethyl ketone, methyl ethyl ketone (2-butanone) and methyl isobutyl ketone; ethers, such as tetrahydrofuran (THF), 2-methyltetrahydrofuran (2-MeTHF) and 1,2-dimethoxyethane; 1,3-dioxolane; dimethylsulfoxide (DMSO); and, dichloromethane (DCM).

The sequential stages of the free-radical emulsion polymerization are performed in the presence of a surfactant. Surfactant can be added to a monomer mixture to form a pre-emulsion, or surfactant can be added directly to the polymerization reactor during the emulsion polymerization; alternatively both modes of addition may be used. In one embodiment, each stage of the emulsion polymerization is carried out in the presence of surfactant constituting from about 0.01 to about 10 wt. %, for example from about 0.1 to about 5 wt. % or from about 0.1 to about 2.5 wt. %, based on the total weight of the polymerizable monomers. In various non-limiting embodiments, all values and ranges of values, both whole and fractional, including and between those set forth above are expressly contemplated for use herein.

It is noted that either reactive surfactants, non-reactive surfactants or both reactive and non-reactive surfactants may be used in the free-radical emulsion polymerization. The term “reactive surfactant” is defined herein to include any surfactant whose molecules are capable of forming polymers, copolymers or crosslinks with itself or with other molecules. Herein, the inclusion of an ethylenic unsaturation in a surfactant molecule—via for example, (meth)acryl-, allyl, vinyl or styryl-groups—may permit the surfactant to be covalently incorporated into the latex copolymer thereby stabilizing the latex and reducing the tendency of the surfactant to migrate.

Independently of reactivity, suitable surfactants include anionic, nonionic, amphoteric, and cationic surfactants, as well as mixtures thereof. More commonly, anionic and nonionic surfactants can be utilized as well as mixtures thereof.

Suitable anionic surfactants for facilitating emulsion polymerizations include, but are not limited to: sodium lauryl sulfate; sodium dodecyl benzene sulfonate; sodium (C₆-C₁₈) alkyl phenoxy benzene sulfonate; disodium (C₆-C₁₈) alkyl phenoxy benzene sulfonate; disodium (C₆-C₁₈) di-alkyl phenoxy benzene sulfonate; disodium laureth-3 sulfosuccinate; sodium dioctyl sulfosuccinate; sodium di-sec-butyl naphthalene sulfonate; disodium dodecyl diphenyl ether sulfonate; disodium n-octadecyl sulfosuccinate; and, phosphate esters of branched alcohol ethoxylates.

Nonionic surfactants suitable for facilitating emulsion polymerizations include, without limitation: linear or branched alcohol ethoxylates; C₈-C₁₂ alkylphenol alkoxylates, such as octylphenol ethoxylates; and, polyoxy (C₂-C₃)alkylene block copolymers. Further useful nonionic surfactants include: C₈-C₂₂ fatty acid esters of polyoxyethylene glycol; mono- and diglycerides; sorbitan esters and ethoxylated sorbitan esters; C₈-C₂₂ fatty acid glycol esters; block copolymers of ethylene oxide and propylene oxide having an hydrophobic-lipophilic balance (HLB) value of greater than 12; ethoxylated octylphenols; and, combinations thereof.

Exemplary commercial surfactants having utility herein include: linear alcohol alkoxylates such as polyethylene glycol ethers of cetearyl alcohol (a mixture of cetyl and stearyl alcohols) available under the trade names PLURAFAC® C-17, PLURAFAC® A-38 and PLURAFAC® A-39 from BASF Corporation; polyoxyethylene-polyoxypropylene block copolymers available under the trade names PLURONIC® F127 and PLURONIC® L35 from BASF Corporation; ethoxylated linear fatty alcohols such as DISPONIL® A 5060 (Cognis), Ethal LA-23 and Ethal LA-50 (Ethox Chemicals); branched alkyl ethoxylates, such as GENAPOL® X 1005 (Clariant Corporation); secondary C₁₂ to C₁₄ alcohol ethoxylates, such as TERGITOL® S15-30 and S15-40 (Dow Chemical Co.); ethoxylated octylphenol-based surfactants, such as TRITON® X-305, X-405 and X-705 (Dow Chemical Co.), IGEPAL® CA 407, 887 and 897 (Rhodia, Inc.), ICONOL® OP 3070 and 4070 (BASF Corporation) and SYNPERONIC® OP 30 and 40 (Uniqema); reactive anionic surfactants, such as Hitenol AR, KH and BC, available from Montello Inc.; Reactsurf 2490, available from Solvay; reactive non-ionic surfactants, such as Noigen RN available from Montello Inc.; sodium vinyl sulfonate, available from Sigma Aldrich; and, block copolymers of ethylene oxide and propylene oxide, such as PLURONIC® L35 and F127 (BASF Corporation).

In certain embodiments, the free radical polymerization may be conducted in the presence of auxiliaries known the emulsion polymerization art. Exemplary auxiliaries include: polymeric stabilizers; emulsifiers; buffering agents; chelating agents; inorganic electrolytes; biocides; antifoam agents; and, pH adjusting agents.

In certain embodiments, the emulsion polymerization may be carried out in the presence of at least one polymeric stabilizer, which stabilizer(s) which may occasionally be identified in the art as protective colloid(s). For instance, polymeric stabilizers may be used in toto in an amount, based on the total weight of the emulsion, of from about 0 to about 10 wt. %, such as from about 0.01 to about 5 wt. % or from about 0.01 to about 2 wt. %. In various non-limiting embodiments, all values and ranges of values, both whole and fractional, including and between those set forth above are expressly contemplated for use herein.

Exemplary synthetic polymeric stabilizers include but are not limited to: polyvinyl alcohol; partially hydrolyzed polyvinyl acetate; polyvinylpyrrolidone; poly(meth)acrylamide; carboxylate-functional addition polymers; and, polyalkylvinyl ethers. Exemplary water-soluble natural polymeric stabilizers include but are not limited to: gelatin; pectins; alginates; casein; and, starch. Exemplary modified natural polymers having utility as polymeric stabilizers include: methylcellulose; methylhydroxyethylcellulose; hydroxypropylcellulose; carboxymethylcellulose; and, allyl modified hydroxyethylcellulose. It is considered that mixtures of synthetic and natural protective colloids may be used, for example, a mixture of polyvinyl alcohol and casein.

Emulsifiers may present in an amount, based on the total weight of the emulsion, of from about 0 to about 10 wt. %, for instance, from about 0.01 to about 5 wt. % or from about 0.01 to about 2 wt. %. In various non-limiting embodiments, all values and ranges of values, both whole and fractional, including and between those set forth above are expressly contemplated for use herein.

Useful emulsifiers are ethoxylated C₁₀-C₂₂ fatty alcohols having from 5 to 250 moles of ethoxylation (EO) and of which examples include: lauryl alcohol ethoxylate; myristyl alcohol ethoxylate; cetyl alcohol ethoxylate; stearyl alcohol ethoxylate; cetearyl alcohol ethoxylate; sterol ethoxylate; oleyl alcohol ethoxylate; and, behenyl alcohol ethoxylate. Mention may in particular be made of the use of one or more of Ceteth-20, Ceteareth-20, Steareth-20 and Behenth-25.

The following describes an exemplary two-stage polymerization process. First a core stage monomer composition comprising:
a monomer mixture comprising:
   i) at least one (meth)acrylate monomer represented by Formula MA;
   optionally ii) at least one vinyl aromatic monomer;
   optionally iii) at least one monomer having at least two (meth)acrylate groups and having a weight average molecular weight (Mw) of at most 600 Daltons;
   optionally iv) at least one carbonyl functional ethylenically unsaturated monomer; and,
   optionally vi) at least one ethylenically unsaturated acid functional monomer;
a chain transfer agent; and,
a solution of surfactant in water
is added to a first vessel with mixing to prepare a monomer pre-emulsion. Optional processing aids can be added as desired.

A polymerization reactor is charged with a desired amount of water, additional surfactant and optional processing aids. The polymerization reactor is equipped with attached inert gas inlet and feed pumps, and the reactor contents are maintained under an inert atmosphere and heated with mixing agitation. The contents of the reactor are brought to the desired polymerization temperature and are maintained at those conditions for from about 0.5 to about 3 hours. A seed stage is performed in a manner consistent with the addition of monomer and surfactant by means of a pre-emulsion as described above. The desired amount of core stage monomer pre-emulsion is fed into the reactor, and a free radical initiator solution is fed separately and concurrently with the core stage monomer composition into the reactor contents over a period of from about 0.5 to about 2 hours. During this time, the reaction temperature is controlled.

After a desired amount of the core monomer composition has been added to the reactor, the feed may be stopped and, if desired, an additional quantity of free radical initiator can optionally be added to the reactor. The resulting reaction mixture can be held at a temperature of about 45 to about 90° C. for a time period sufficient to complete or substantially complete the polymerization reaction and obtain a first stage core copolymer particle emulsion. Where the core-stage monomer composition comprised an ethylenically unsaturated acid functional monomer, a base may be added to the emulsion to neutralize acid groups of the core copolymer.

A shell stage monomer composition containing a desired complement of shell stage monomers and other components listed above for a core stage monomer composition, including if desired a crosslinking agent, can be mixed in a separate vessel following the same procedures as outlined for formulating the core stage monomer composition.

Alternatively, to the first vessel containing remaining material from the core stage monomer composition, a crosslinking agent can be added and mixed with agitation to form a shell stage or second stage monomer composition. Additional shell stage monomers can be added into the composition if desired.

The shell stage or second stage monomers are metered into the polymerization reactor at a constant rate and mixed with the core copolymer emulsion. Simultaneously with the shell stage monomer feed, a free radical initiator solution in an amount sufficient to re-initiate polymerization is metered into the reaction mixture, such that the shell stage or second stage monomers are polymerized in the presence of the core stage or first stage copolymer. The polymerization temperature is maintained for from about 0.5 to about 3 hours or until polymerization is complete. Unreacted monomer can be eliminated by completing a monomer chase step, which may entail the addition of more initiator or the adjustment of temperature for a period of time to maintain radical flux from initiator residues, as is known in the emulsion polymerization art.

The presence of residual monomers in the reaction mixture can be monitored by gas chromatography (GC). Alternatively or additionally, the progress of each stage of the polymerization reaction may be monitored by particle size analysis or solids content analysis. When a desired level of monomer conversion is attained, the reactor contents are cooled and then, where applicable, partially or wholly neutralized by the addition of the appropriate amount of base.

Typically, the product emulsion comprising the core-shell latex copolymer has a total copolymer solids content of from about 10 to about 60 wt. %, for example from about 10 to about 50 wt. % or from about 10 to about 45 wt. %. In various non-limiting embodiments, all values and ranges of values, both whole and fractional, including and between those set forth above are expressly contemplated for use herein.

It should be recognized, however, that an initially formed aqueous emulsion may be concentrated by distilling off—under reduced pressure—a portion of the water, any co-solvent present and any unreacted starting materials. The complete distillation off of such compounds is not precluded as this permits the isolation of the core-shell copolymer in dried powder form. The aqueous copolymer emulsion, concentrated aqueous copolymer emulsion or any dried powder obtained therefrom, may be stored upon production: the core-shell copolymers should be disposed in a vessel with an airtight and moisture-tight seal, which vessel should desirably not permit the penetration of photo-irradiation.

### Carbonyl Functional Co-binder(s)

In certain embodiments, the binder of the water-borne composition may further comprise (a2) at least one co-(co)polymer which is distinct from the core-shell latex copolymer (a1) but which is reactive towards the polyhydrazide compounds present in the composition. The water-borne composition may comprise, based on the weight of the composition, from about 0 to about 20 wt. % of (a2) said at least one (co)polymer.

The inclusion or otherwise of the (co)polymer (a2) will be one determinant of the solids content of the water-borne composition. The ratio by weight of solids of constituent (a1) the core-shell latex copolymer to solids of constituent (a2) may be from about 100:0 to about 100:50, for example from about 100:1 to about 100:50, from about 100:1 to about 100:35, from about 100:1 to about 100:20 or from about 100:1 to about 100:10. In various non-limiting embodiments, all values and ranges of values, both whole and fractional, including and between those set forth above are expressly contemplated for use herein.

The (co)polymer (a2) may be distinguished from the core-shell latex copolymer (a1) by morphology where it does not possess a core-shell structure. Alternatively or additionally, a (co)polymer (a2) may be distinguished from the core-shell latex copolymer (a1) by its constituent monomer residues.

An exemplary (co)polymer (a2) may be a carbonyl functionalized polymer chosen from: poly(meth)acrylate; polyamide; polyester; polyether; polyolefin; polyurethane; or a copolymer thereof. In certain embodiments, the composition includes at least one co-binder chosen from: poly(meth)acrylates having pendant carbonyl groups; polyurethanes having pendant carbonyl groups; polyesters having pendant carbonyl groups; and, mixtures thereof.

### B) Crosslinker

The crosslinker of the present composition comprises (b1) at least one polyhydrazide. The at least one polyhydrazide is included in the water-borne composition in such an amount that the molar ratio of hydrazide groups to carbonyl groups in the composition is from about 5:1 to about 1:5. The composition may be exemplified by a molar ratio of hydrazide groups to carbonyl groups of from about 3:1 to about 1:3, for example from about 2:1 to about 1:2. In various non-limiting embodiments, all values and ranges of values, both whole and fractional, including and between those set forth above are expressly contemplated for use herein.

In addition to the aforementioned molar ratio term, the water-borne composition may be exemplified by comprising, based on the weight of the composition, from about 5 to about 30 wt. % of (b1) said at least one polyhydrazide. For instance, the composition may comprise from about 5 to about 25 wt. % or from about 5 to about 20 wt. % of (b1) said at least one polyhydrazide. In various non-limiting embodiments, all values and ranges of values, both whole and fractional, including and between those set forth above are expressly contemplated for use herein.

By a “polyhydrazide” is meant a compound bearing at least two hydrazide groups of the formula —C(═O)—NH—N(R^{h})(Rⁱ), wherein R^{h} and Rⁱ are independently H or C₁-C₁₂ alkyl. Such hydrazide groups are usually part of larger groups, such as those of formulae -L-C(═O) NH—N(R^{h})(Rⁱ), wherein L is a divalent linking group chosen from —O—, —NH—, C₁-C₁₈ alkylene, C₂-C₁₈ alkenylene, C₃-C₁₈ cycloalkylene or C₆-C₁₈ arylene. That aside, in certain embodiments, the polyhydrazide may be exemplified by having from 2 to 5 hydrazide functional groups, for example from 2 to 4 hydrazide functional groups. The use of dihydrazide compounds may in particular be mentioned.

The polyhydrazide may be polymeric or non-polymeric: combinations thereof are also envisaged. Illustrative non-polymeric polyhydrazides are the hydrazide derivatives of aliphatic, cycloaliphatic or aromatic polycarboxylic acids: these are obtainable by the reaction of hydrazine with the respective polycarboxylic acid.

In accordance with an important embodiment of the present disclosure, component (b2) comprises at least one dihydrazide having the formula (DH1):

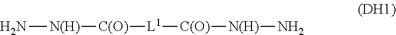

wherein: L¹ is a divalent linking group chosen from a covalent bond, C₁-C₁₈ alkylene, C₂-C₁₈ alkenylene, C₃-C₁₈ cycloalkylene or C₆-C₁₈ arylene.

Exemplary dihydrazides in accordance with Formula DH1 include: maleic acid dihydrazide; fumaric acid dihydrazide; itaconic acid dihydrazide; oxalic acid dihydrazide; malonic acid dihydrazide; succinic acid dihydrazide; adipic acid dihydrazide (ADH); phthalic acid dihydrazide; terephthalic acid dihydrazide; glutaric acid dihydrazide; sebacic acid dihydrazide; cyclohexane-1,4-dicarbohydrazide; and, azelaic acid dihydrazide. As intimated above, said dihydrazides may be obtained by reaction of hydrazine with the corresponding dicarboxylic acid.

Polymeric hydrazides are polymers which possess at least two hydrazide groups, for instance from 2 to 5 hydrazide groups. Exemplary polymeric hydrazides may possess a weight average molecular weight (Mw) of from about 1 to about 2000 kDa, for example from about 1 to about 1000 kDa or from about 1 to about 500 kDa. In various non-limiting embodiments, all values and ranges of values, both whole and fractional, including and between those set forth above are expressly contemplated for use herein.

Polymeric hydrazides may be obtained by reacting either hydrazine (H₂NNH₂) or a derivative thereof with a polymer having pendant anhydride, epoxide, carboxylic acid or isocyanate groups. The hydrazine reactant may be represented by the formula H₂N—N(R^{h})(Rⁱ), wherein R^{h} and Rⁱ are independently H or C₁-C₁₂ alkyl. Exemplary reactant polymers include but are not limited to: isocyanate functional polyurethanes; and, carboxylic acid functional poly(alkyl (meth)acrylates), such as carboxylic acid functional poly(C₁-C₁₂ alkyl (meth)acrylates). Isocyanate functional polyurethanes may, in certain embodiment be obtained by the reaction of a polyisocyanate with a polyol under conditions wherein the —NCO groups are in stoichiometric excess to the active hydrogen atoms of the polyol; illustrative reactant polyols may be chosen from: polyester polyols; polyether polyols; polycarbonate polyols; and, mixtures thereof.

### (c) Additives and Adjunct Ingredients

The water-borne compositions will typically further comprise adjuvants and additives that can impart improved properties to these compositions. For instance, the adjuvants and additives may impart one or more of: improved adhesion to substrates; reduced corrosivity towards the substrate surface; improved elastic properties; improved elastic recovery; longer enabled processing time; faster curing time; lower residual tack and, improved levelling. Included among such adjuvants and additives are: adhesion promoters; corrosion inhibitors; catalysts; cure retarders; surfactants, as described hereinabove; wetting agents; plasticizers; stabilizers; tougheners; rheology control agents; biocides; flame retardants; colorants; organic co-solvents; and, non-reactive diluents.

Such adjuvants and additives can be used in such combination and proportions as desired, provided they do not adversely affect the nature and essential properties of the composition. While exceptions may exist in some cases, these adjuvants and additives should not in toto comprise more than about 50 wt. % of the total composition.

As the present disclosure envisages the utility of multi-part compositions, it is noted that adjunct materials and additives which contain reactive groups may be disposed within a part of the composition which is separate from the binder and crosslinker as described above. Alternatively, those adjunct materials and additives which contain reactive groups may be blended together with the appropriate one of the binder or cross-linker parts to ensure the storage stability thereof. Unreactive adjunct materials may be formulated into any of the parts of the composition.

The addition of certain additives may promote the adhesion of the coating compositions to particular substrates. In this regard, the composition of the present disclosure may comprise from 0 to 5 wt. %, for example from 0.5 to 5 wt. % based on the weight of the composition, of at least one additive chosen from: morin (2-(2,4-dihydroxy phenyl)-3,5,7-trihydroxy-4H-1-cumarone-4-ketone); 3,7-dihydroxy-2-naphthoic acid (3,7-dihydroxy naphthlene-2-carboxylic acid); pyrogallol carboxylic acid (2,3,4-trihydroxybenzoic acid); 3,4-dihydroxy-benzene guanidine-acetic acid; gallic acid (3,4,5-trihydroxybenzoic acid); para-aminosalicylic acid (4-amino-2-hydroxybenzoic acid, PAS); flutter acid (4,4′-methylene-bis(3-hydroxy-2-naphthoic acid)); citric acid (2-hydroxypropane-1,2,3-tricarboxylic acid); and, mixtures thereof. Of these compounds, the use—alone or in combination—of citric acid, gallic acid or para-aminosalicylic acid (PAS) may be mentioned.

In certain embodiments, the composition may comprise from about 0 to about 5 wt. %, for example from about 0.5 to about 5 wt. % based on the weight of the composition of at least one silane coupling agent. Such compounds, which should typically possess from 1 to 3 hydrolyzable functional groups, can serve to enhance the adhesion of the curing composition to a given surface. More particularly, the hydrolyzable silane groups of the coupling agent can react with the surface to remove unwanted hydroxyl groups. The coupling agent might further include non-hydrolyzable functional groups which may react with the film-forming polymer(s) to chemically link said polymer(s) with the surface.

Examples of suitable silane coupling agents include but are not limited to: aminosilanes, such as γ-aminopropyltrimethoxysilane, γ-aminopropyltriethoxysilane, N-(β-aminoethyl)-γ-aminopropyltrimethoxy-silane, N-(β-aminoethyl)-γ-aminopropyltriethoxysilane, bis(γ-trimethoxysilylpropylamine), γ-ureidopropyl-trimethoxysilane, 4-amino-3,3-dimethylbutyltrimethoxysilane, 4-amino-3,3-dimethylbutylmethyl-dimethoxysilane, and, N-ethyl-γ-aminoisobutyltrimethoxysilane; glycidoxy polymethylenetrialkoxysilanes, such as 3-glycidoxy-1-propyl-trimethoxysilane; (meth)acryloxypolymethylenetrialkoysilanes, such as γ-methacryloxypropyltrimethoxysilane, γ-methacryloxypropyltriethoxysilane and γ-methacryloxypropyl-triisopropoxysilane; γ-methacrylamidopropyltrimethoxysilane; γ-glycidoxypropyltrimethoxysilane; α-glycidoxypropylmethyldiethoxysilane; vinyl-tris-(2-methoxyethoxy) silane; and, α-chloropropyl-trimethoxysilane.

A corrosion inhibitor may be included in the water-borne composition in an amount up to about 5 wt. %, based on the weight of the composition. When added, it is typical for the composition to comprise from about 0.1 to about 2 wt. %, for instance from about 0.1 to about 1 wt. % of corrosion inhibitor. Exemplary corrosion inhibitors, which may be present alone or in combination in the composition, include salts of alkali metals, alkaline earth metals and transition metals, such as titanium, chromium and zinc. Mention may be made of: magnesium oxide, magnesium hydroxide; magnesium carbonate; magnesium phosphate; magnesium silicate; zinc oxide; zinc hydroxide; zinc carbonate; zinc phosphate; and, zinc silicate.

In certain embodiment, tougheners may be included in the water-borne composition in an amount up to about 10 wt. %, based on the weight of the composition. Exemplary tougheners may be chosen from: epoxy-elastomer adducts; and, toughening rubber in the form of dispersed core-shell particles which do not possess pendant reactive groups.

It will be appreciated that the aforementioned reaction of (a1) said core-shell latex copolymer and (b1) said polyhydrazide compound(s) may provide all of the film-forming resin of the water-borne composition in some embodiments. The further provision in the composition of a carbonyl-functional (co)polymer, distinct from (a1) said core-shell latex copolymer is also envisaged. However, in certain embodiments, the composition may comprise up to about 35 wt. %, for instance up to about 30 wt. % or up to about 25 wt. %, based on the solids content of the composition, of one or more supplementary film-forming resins. Any such supplementary film-forming resins included in the composition may be thermosetting or thermoplastic but should be either dispersible, emulsifiable or soluble in water.

The rheology control agent which may optionally be included in the present composition may typically comprise fillers, thickeners and combinations thereof. The total amount of rheology control agent in the composition should not generally exceed about 40 wt. %, based on the weight of the composition. The composition may comprise, for example, from about 0 to about 35 wt. % or from about 0 to about 40 wt. % of rheology control agent, based on the weight of the composition.

Exemplary thickeners include but are not limited to: clay based thickeners, such as organoclays; polysaccharides, such as guar and xanthan; polyacrylates; and, associative thickeners. Mention may, in particular, be made of the use as a polysaccharide thickener of cellulose or cellulose derivatives, such as: carboxymethylcellulose; methylcellulose; hydroxyethylcellulose; hydroxyethylmethylcellulose; hydroxypropylmethylcellulose; cellulose nanofibers; and, cellulose nanocrystals.

Broadly, there is no particular intention to limit the shape of the particles employed as fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as fillers. However, such fillers will conventionally have an d₅₀ particle size, as measured by laser diffraction, of from 0.1 to 1500 μm, for example from 1 to 1250 μm.

Exemplary fillers include but are not limited to calcium carbonate, calcium oxide, calcium hydroxide (lime powder), precipitated and/or pyrogenic silica, zeolites, bentonites, wollastonite, magnesium carbonate, diatomite, barium sulfate, aluminum oxide, aluminium silicate, clay, talc, titanium oxide, iron oxide, zinc oxide, sand, quartz, flint, mica, glass beads, glass powder, and other ground mineral substances. Organic fillers can also be used, in particular wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added.

When present, pyrogenic and/or precipitated silica should desirably have a BET specific surface area of from 10 to 90 m²/g. When they are used, they do not cause any additional increase in the viscosity of the composition according to the present disclosure, but do contribute to strengthening the cured composition.

It is likewise conceivable to use pyrogenic and/or precipitated silica having a higher BET specific surface area, advantageously from 100 to 250 m²/g as a filler: because of the greater BET surface area, the effect of strengthening the cured composition is achieved with a smaller proportion by weight of silicic acid.

Also suitable as fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of about 1 mm or less, typically about 500 μm or less.

Fillers which impart thixotropy to the composition may be typical for many applications. Such fillers are also described as rheological adjuvants and include, for example, hydrogenated castor oil, fatty acid amides and swellable plastics, such as PVC.

A “plasticizer” for the purposes of this disclosure is a substance that decreases the viscosity of the composition and thus facilitates its processability. Herein the plasticizer may constitute up to about 10 wt. % or up to about 5 wt. %, based on the total weight of the composition, and is typically chosen from: diurethanes; ethers of monofunctional, linear or branched C4-C16 alcohols, such as Cetiol OE (obtainable from BASF); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not typical due to their toxicological potential.

“Stabilizers” for purposes of this disclosure are to be understood as antioxidants, UV stabilizers, thermal stabilizers or hydrolysis stabilizers. Herein stabilizers may constitute in toto up to about 10 wt. % or up to about 5 wt. %, based on the total weight of the composition. Standard commercial examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphorus; sulfur; and, mixtures thereof.

The term “colorant” as used herein refers to any substance that imparts one or more of color, opacity or a visual effect to the composition. Visual effects which may be imparted to the composition by the colorant, in addition to or independently of color, include: reflectance; pearlescence; sheen; texture; phosphorescence; fluorescence; photochromism; photosensitivity; thermochromism; and, goniochromism. The term “colorant” is intended to encompass: organic pigments; inorganic pigments; dyes; and, tints. More than one colorant may be included in the composition and it is considered that each added colorant can independently be added in any suitable form, of which mention may be made of discrete particles, dispersions and solutions.

As noted above, the compositions are aqueous and thus predominantly contain water as the solvent or as the continuous phase of a dispersion. In certain embodiments however, the composition may further comprise organic co-solvents and/or non-reactive diluents where these can usefully moderate the viscosity of the composition. Exemplary co-solvents and non-reactive diluents include but are not limited to: aromatic solvents, such as xylene, toluene and cumene; C₁-C₆ alkanols, such as methanol, ethanol, n-propanol, i-propanol, n-butanol, s-butanol, t-butanol, or n-pentanol; ether solvents, such as ethylene glycol dimethyl ether, ethylene glycol diethyl ether, ethylene glycol dibutyl ether, ethylene glycol diphenyl ether, diethylene glycol, diethylene glycol-monomethyl ether, diethylene glycol-monoethyl ether, diethylene glycol-mono-n-butyl ether, diethylene glycol dimethyl ether, diethylene glycol diethyl ether, diethylene glycoldi-n-butylyl ether, propylene glycol butyl ether, propylene glycol phenyl ether, dipropylene glycol monomethyl ether, dipropylene glycol dimethyl ether and dipropylene glycoldi-n-butyl ether; petroleum fractions such as naphtha and Solvesso® products (available from Exxon); acetates, including glycol ether acetates; propionates, such as ethyl 3-ethoxypropionate, isobutyrates, such as methyl isobutyrate, ethyl isobutyrate, isobutyl isobutyrate and 3-hydroxy-2,2,4-trimethylpentyl isobutyrate (Texanol); adipates; sebacates; phthalates; benzoates; organic phosphoric or sulfonic acid esters; and, sulfonamides.

It is typical that co-solvents and non-reactive diluents constitute in toto less than about 10 wt. %, for example less than about 8 wt. % or less than about 5 wt. %, based on the total weight of the composition. The at least partial exclusion of these co-solvents and non-reactive diluents enables the water-borne composition to possess a volatile organic compound (VOC) content, as measured in accordance with ISO 11890-2:2006, of at most about 420 g/l, for instance at most about 360 g/l, such as at most about 300 g/l or even at most about 240 g/l. In various non-limiting embodiments, all values and ranges of values, both whole and fractional, including and between those set forth above are expressly contemplated for use herein.

### Methods and Applications

To prepare the curable compositions of the present disclosure, the ingredients thereof should be mixed under sufficient shear forces to yield a homogeneous mixture. One-part (1K) compositions brought together in this manner, whilst curable, can demonstrate storage stability in that the polyhydrazide compound remains unreactive until being exposed to certain conditions, such as an increased pH caused by evaporation of amine from the composition. For the aforementioned multi-part curable compositions of certain embodiments of the disclosure, the reactive parts—and optionally diluents, such as water—are brought together and mixed in such a manner as to induce the hardening thereof. It is considered that this mixing can be achieved without special conditions or special equipment. That said, suitable mixing devices might include: static mixing devices; magnetic stir bar apparatuses; wire whisk devices; stick mixing devices, such as wooden tongue depressors; augers; batch mixers; planetary mixers; C.W. Brabender or Banburry® style mixers; and, high shear mixers, such as blade-style blenders and rotary impellers.

Upon mixing, the water-borne compositions will conventionally contain from about 10 to about 70 wt. %, for example from about 20 to about 70 wt. % or from about 30 to about 60 wt. %, based on the weight of the composition, of water. In an alternative but not mutually exclusive expression, the composition may be defined by a viscosity of from about 0.05 to about 2 Pa·s, for example about 0.05 to about 1.5 Pa·s or from about 0.05 to about 1 Pa·s measured using a Brookfield viscometer at about 25° C. immediately upon mixing of all ingredients thereof. The term “immediately” shall be construed as a time period not exceeding 5 minutes. In various non-limiting embodiments, all values and ranges of values, both whole and fractional, including and between those set forth above are expressly contemplated for use herein.

There is no particular intention to the limit the substrates to which the present compositions may be applied. In application to vehicular panels, exemplary substrates may be metallic, polymeric or a combination thereof. However, particular mention may be made of: ferrous metals, such as iron, steel, and alloys thereof; non-ferrous metals, such as aluminum, zinc and alloys thereof; and, combinations thereof. In illustrative embodiments, the substrate may be formed from: cold rolled steel; electro-galvanized steel, such as hot dip electro-galvanized steel or electro-galvanized iron-zinc steel; or, aluminum.

The above described compositions are applied to the material layer(s) and then cured in situ. Prior to applying the compositions, it is often advisable to pre-treat the relevant surfaces. Any such pre-treatment should comprise at least one of: cleaning the surface(s); abrading the surface(s); applying an anti-corrosion coating; or, applying a conversion coating or conversion treatment thereto.

Cleaning serves to remove foreign matter from the surface. Cleaning treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; wiping the surface with a dry wipe; wiping the surface with a wet wipe which has been moistened with a cleaning solution, such as an aqueous solution of a phosphate salt; and, water rinsing, typically with deionized or demineralized water. In those instances where a waterborne alkaline degreasing bath is used, any of the degreasing agent remaining on the surface should typically be removed using wipes and/or by rinsing the substrate surface with deionized or demineralized water.

Having regard to utility of the compositions as a primer in an automotive refinishing process, after such cleaning of the substrate surface, any defect area therein may be sanded and, optionally, feather-edged such that the thickness of the edge of an existing surface finish is reduced to accommodate the new finish. Both sanding and feather-edging may be effected using, for instance, an orbital sander having sandpaper of a pre-determined grit. After sanding, the defect area may optionally be cleaned again to remove any dust generated during the sanding operation or any other acquired dirt or contaminants.

The terms “conversion coating” and “conversion treatment” refer to a treatment of the surface of a substrate which causes the surface material to be chemically converted to a different material. Typically, a metal or alloyed surface substrate, presenting a defect area for refinishing, is chemically treated to provide a tightly adherent conversion coating, all or part of which consists of a stabilized form—for instance an oxidized form—of the substrate metal. Such chemical conversion coatings can demonstrate high corrosion resistance as well as providing a strong bonding affinity for subsequent coating layers.

The compositions of the present disclosure are then applied to the typically pre-treated surfaces of the substrate by conventional application methods such as: brushing; roll coating; knife coating; doctor-blade application; printing methods; and, spraying methods, including but not limited to air-atomized spray, air-assisted spray, airless spray and high-volume low-pressure spray.

It is recommended that the compositions be applied to a surface at a wet film thickness of from about 10 to about 500 μm, for example from about 10 to about 250 μm or from about 20 to about 150 μm. In various non-limiting embodiments, all values and ranges of values, both whole and fractional, including and between those set forth above are expressly contemplated for use herein. The application of thinner layers within the given ranges is more economical and provides for a reduced likelihood of deleterious thick cured regions. However, great control must be exercised in applying thinner coatings or layers so as to avoid the formation of discontinuous cured films.

The curing of the applied compositions of the disclosure typically occurs at temperatures in the range of from about 20° C. to about 120° C., such as from about 20° C. to about 100° C. or from about 20° C. to about 80° C. In various non-limiting embodiments, all values and ranges of values, both whole and fractional, including and between those set forth above are expressly contemplated for use herein. The temperature that is suitable depends on the specific compounds present and the desired drying and curing rate and can be determined in the individual case by the skilled artisan, using simple preliminary tests if necessary. Of course, drying and curing at lower temperatures within the aforementioned ranges is advantageous as it obviates the requirement to substantially heat or cool the mixture from the usually prevailing ambient temperature. Where applicable, however, the temperature of the mixture formed from the respective parts of the composition may be raised above the mixing temperature and/or the application temperature using conventional means including microwave induction, ovens and drying booth. The elevated temperature may be maintained for up to 60 minutes to ensure complete curing.

The coating method of the present disclosure may further comprise reducing the oxygen content in the environment of the curing material: this may done by introducing nitrogen (N₂) gas into the curing environment. This step is however not necessary for the formation of a robust coating.

The cured composition should typically fill the defect area and any further minor flaws in the surface of the substrate to which it is applied and may thereby present a smooth surface for the application of subsequent coating layer(s). Further, once fully cured after application to the surface of a substrate, the cured composition may be sanded using, for instance, an orbital sander having sandpaper of a pre-determined grit. The sanded surface may, again, be cleaned to remove any dust generated during the sanding operation or any other acquired dirt or contaminants.

It is not precluded that the curable composition of the present disclosure be applied in a number of films to attain the desired coating thickness of the cured composition and to cover surface imperfections. In this circumstance, an applied film of the curable composition may be at least partially cured prior to the application of a subsequent film. For example, an applied film of the curable composition may be subjected to a thermal treatment which “flashes off” at least a portion of the constituent water but which does not fully cure the composition; a further film of the curable composition is then applied over the partially cured film and the resultant article is subjected to a curing condition which fully cures both of said films.

In an embodiment of the disclosure, there is provided an article comprising: a metallic substrate; and, a multilayer coating disposed on the metallic substrate, wherein at least one layer of the multilayer coating comprises the cured compositions as described herein. Whilst the use of the cured compositions as a solid-color base coat, a solid-color top coat and/or a clear coat within such a multilayer coating is not precluded, the cured coating compositions are more suited for use in or as a primer layer thereof.

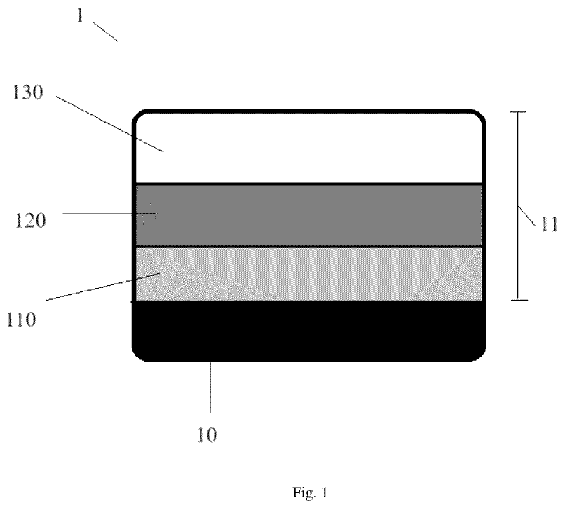

An exemplary article is illustrated in FIG. 1 appended hereto. The illustrated article (1) comprises: a metallic substrate (10); and, a multilayer coating (11) disposed on the metallic substrate, wherein the multilayer coating (11) comprises: a primer layer (110) disposed on the metallic substrate, said primer layer (110) comprising the cured product of the above-described composition; a base coat layer (120) comprising a color and/or visual effect imparting compound, wherein the base coat layer is disposed on the primer layer (110); and, a clear coat layer (130) which is disposed on the base coat layer (120).

The primer layer (110) is typically applied to promote adhesion between the substrate surface and the subsequent coating layers. Moreover, the primer coating layers may serve to enhance the physical properties of the overall coating system, in particular the corrosion resistance and the impact strength thereof. Still further, the primer coating layer can contribute to the overall appearance of the coating system by providing a smooth layer upon which the subsequent layers may be applied.

The primer layer (110), which may typically comprise the cured product of the above-described composition, is depicted in FIG. 1 as being disposed on and in direct contact with the metallic substrate (10). It will however be appreciated that one or more intermediate coating layers may be disposed between the metallic substrate and the primer layer (110). A conversion coating layer is a representative example of such an intermediate coating layer, which chemical conversion coatings can demonstrate high corrosion resistance as well as providing a strong bonding affinity for the subsequent primer layer (110).

A single primer layer (110) is depicted in FIG. 1 for illustrative purposes only. In certain embodiments, however, more than one primer layer (110) may be present. Irrespective of whether primer is applied in a single or multilayer manner, the total thickness of the at least one primer layer may typically be from about 10 to about 200 microns, such as from about 10 to about 150 microns, from about 10 to about 75 microns or from about 20 to about 75 microns. In various non-limiting embodiments, all values and ranges of values, both whole and fractional, including and between those set forth above are expressly contemplated for use herein.

That base coat layer (120) of FIG. 1 comprises a color and/or visual effect imparting compound and is disposed on the primer layer (110). Where primer has been applied in a multilayer manner, the base coat layer is disposed on the uppermost primer layer relative to surface of the metallic substrate (10).

A single base coat layer (120) is depicted in FIG. 1 for illustrative purposes only. In certain embodiments, however, more than one base coat layer (120) may be present. The lowermost of those base coat layers may be disposed on and in direct contact with a primer layer (110). Irrespective of whether the base coat is applied in a single or multilayer manner, the total thickness of the at least one basecoat layer may typically be from about 5 to about 100 microns, such as from about 5 to about 50 microns, from about 5 to about 40 microns or from about 5 to about 30 microns. In various non-limiting embodiments, all values and ranges of values, both whole and fractional, including and between those set forth above are expressly contemplated for use herein.

In FIG. 1, a clear coat layer (130) is disposed on the base coat layer (120). Where the base coat has been applied in a multilayer manner, the clear coat layer (130) would be disposed on the uppermost base coat layer relative to surface of the metallic substrate (10). The clear coat layer (130) typically possesses good chemical resistance as well as resistance to mechanical wear and weathering. Further, the clear coat layer (130) will have satisfactory optical properties, including transparency and gloss.

Again, a single clear coat layer (130) is depicted in FIG. 1 for illustrative purposes only. In certain embodiments, however, more than one clear coat layer (130) may be present. The lowermost of those clear coat layers may be disposed on and in direct contact with the base coat layer (120). Irrespective of whether the clear coat is applied in a single or multilayer manner, the total thickness of the at least one clear coat layer may typically be from about 10 to about 500 microns, such as from about 10 to about 200 microns, from about 20 to about 100 microns or from about 30 to about 90 microns. In various non-limiting embodiments, all values and ranges of values, both whole and fractional, including and between those set forth above are expressly contemplated for use herein.

Each clear coat layer (130) of the article may, in certain embodiments, be at least substantially transparent to visible light. Thus, for example, each clear coat layer may be at least about 85%, at least about 90% or at least about 95% transparent to visible light, as determined using transmittance (T_{R}) measurements in accordance with ASTM D1746 (2023).

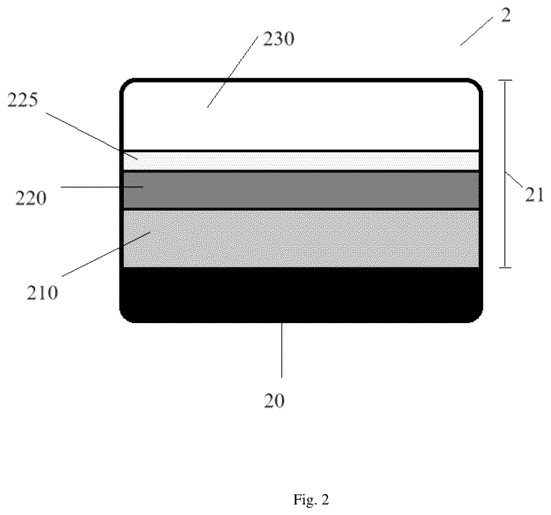

A further exemplary article is illustrated in FIG. 2 appended hereto. The illustrated article (1) comprises: a metallic substrate (20); and, a multilayer coating (21) disposed on the metallic substrate, wherein the multilayer coating (21) comprises: a primer layer (210) disposed on the metallic substrate, said primer layer (210) comprising the cured product of the above-described composition; a base coat layer (220) comprising a color and/or visual effect imparting compound, wherein the base coat layer is disposed on the primer layer (210); a tie layer (225) disposed on the base coat layer (220); and, a clear coat layer (230) which is disposed on the tie layer (225).

The tie layer (225) can be interposed between—and can enhance the adhesion of—a base coat layer (220) and a clear coat layer (230). Given this interposition, the tie layer (225) may typically be substantially transparent to visible light. Thus, for example, the tie layer (225) layer may be at least about 85%, at least about 90% or at least about 95% transparent to visible light, as determined using transmittance (T_{R}) measurements in accordance with ASTM D1746 (2023).

A single tie layer (225) is depicted in FIG. 2 for illustrative purposes only. In certain embodiments, however, more than one tie layer (225) may be present. The lowermost of those tie layers may be disposed on and in direct contact with the base coat layer (220); a clear coat layer (230) comprising the cured product of the above-described composition would be disposed on and in direct contact with the uppermost of the tie layers (225) in these embodiments. The total thickness of the at least one tie layer may in embodiments be less than the total thickness of the clear coat layer(s) (230). Alternatively or additionally, the total thickness of the at least one tie layer may be from about 1 to about 50 microns, such as from about 1 to about 25 microns, from about 5 to about 25 microns or from about 5 to about 20 microns. In various non-limiting embodiments, all values and ranges of values, both whole and fractional, including and between those set forth above are expressly contemplated for use herein.

The process of forming a multilayer coating will conventionally incorporate the steps of: i) providing a metallic substrate; ii) applying a first layer of a first coating composition on and in direct contact with the metallic substrate; iii) at least partially curing or at least partially drying that first layer; iv) applying a second layer of a second coating composition on and in direct contact with the at least partially cured or at least partially dried first layer; v) at least partially curing or at least partially drying that second layer; vi) applying a third layer of a third coating composition on and in direct contact with the at least partially cured or at least partially dried second layer; and, vii) at least partially curing or at least partially drying that third layer. In an iterative process, steps vi) and vii) may be performed and repeated so as to dispose fourth and further layers on the metallic substrate. Having regard to the multilayer coatings illustrated in FIGS. 1 and 2, the first, second, third and further compositions provide: at least one primer layer; at least one base coat layer; optionally at least one tie layer; and, at least one clear coat layer as described above.

The metallic substrate provided in step i) may typically be pre-treated prior to step ii). Such pre-treatment may comprise at least one of: cleaning the surface(s) of the metallic substrate; abrading the surface(s) of the metallic substrate; applying an anti-corrosion coating to the metallic substrate; or, applying a conversion coating to the metallic substrate, as described above.

Independently of the cleaning of the substrate, the surface of the metallic substrate (10) may be abraded. Abrading typically includes sanding which may be performed using, for instance, an orbital sander having sandpaper of a pre-determined grit. After surface abrasion, the metallic substrate may optionally be cleaned to remove any dust generated during the abrasion operation or any other acquired dirt or contaminants.

As used in the described process, the term “at least partially cured” means that curing of the curable coating composition has been initiated and that, for example, cross-linking of components of the composition has commenced. The term encompasses any amount of cure upon application of the curing condition, from the formation of a single cross-link to a fully cross-linked state. The rate at which the coating composition cures is contingent on various factors, including the components thereof, functional groups of the components and the parameters of the curing condition.

At least partial solidification of a given coating layer is generally indicative of cure or drying. However, both drying and cure may be indicated in other ways including, for instance, a viscosity change of the coating layer, an increased temperature of that coating layer and/or a transparency/opacity change of that coating layer.

It may be typical for steps iv) and vi) of the above described application process to be commenced only when the at least partially cured or partially dried preceding layer can substantially retain its shape upon exposure to ambient conditions. By “substantially retain its shape” is meant that at least about 50% by volume, and more usually at least about 80% or about 90% by volume of the at least partially cured or dried layer retains its shape and does not flow or deform upon exposure to ambient conditions for a period of about 5 minutes. Under such circumstances, gravity typically may not substantially impact the shape of the at least partially cured or partially dried layer upon exposure to ambient conditions.

The shape of the at least partially dried or at least partially cured layer may typically impact whether the layer substantially retains its shape. For example, when the layer is rectangular or has another simplistic shape, the at least partially cured or dried layer may be more resistant to deformation at even lesser levels of cure or even lesser degrees of drying than layers having more complex shapes.

In certain embodiments, the application of each subsequent layer (step iv); step vi)) occurs before an at least partially cured or partially dried layer has reached a final cured state, nominatively while the layer is still “green”. In such embodiments, application of the layers may be considered “wet-on-wet” such that the adjacent layers at least physically bond, and may also chemically bond, to one another. For example, it is possible that components in each of the first and subsequent layers can chemically cross-link/cure across the application line, which effect can be beneficial to the longevity, durability and appearance of the finished article. The distinction between partial cure and a final cured state is whether the partially cured layer can undergo further curing or cross-linking. This does not actually preclude functional groups being present in the final cured state but such groups may remain un-reacted due to steric hindrance or other factors.

In the aforementioned iterative process, the thickness, width, shape and continuity of each layer may be independently selected such that the preceding and subsequent layer may be the same or different from one another in one or more of these regards. For example, a given subsequent layer may only contact a portion of an exposed surface of the at least partially cured or dried preceding layer: depending on the desired shape of the coating layer, the subsequent layer may build on that layer selectively.

Various features and embodiments of the disclosure are described in the following examples, which are intended to be representative and not limiting.

### EXAMPLES

The following products and commercial products are used in the Examples.
Sipomer WAM-II: N-(2-methacrylamidoethyl)ethylene urea, available from Solvay.
SR213: 1,4-butanediol diacrylate, available from Arkema
VeoVa 10: Vinyl Neodecanoate, available from Hexion Inc.
Aerosol EF800: Monoester sulfosuccinate emulsifier, available from Solvay.
Rhodacal DS-4: Anionic surfactant, available from Solvay.
Surfynol 104H: Non-ionic surfactant (75 wt. % solution in ethyl glycol monobutyl ether) available from Evonik Industries.
Hitenol BC 1025: Reactive surfactant (25% active) available from Montello Inc.
Solsperse 27000: Alkylphenol ethoxylates-free (APE-free) polymeric dispersant, available from Lubrizol.
Dispersant 1: Quaternary ammonium salt of a polyacrylic acid having an acid value of 106 mgKOH/g solids; 35 wt. % of dispersant in a 1:3 mixture of isopropyl alcohol and water.
Dispersant 2: Quaternary ammonium salt of a polyacrylic acid having an acid value of 44 mgKOH/g solids; 40 wt. % of dispersant in water.
ACD: Acrylic copolymer dispersion prepared in accordance with Example 2 of European Patent No. 1 784 463 B1.
BruggoliteR FF6M: Disodium salt of 2-hydroxy-2-sulfonatoacetic acid, available from Brueggemann KG.

The remaining ingredients mentioned herein below are available from Sigma Aldrich.

The following test methods were performed on the coatings obtained from the compositions described herein below:
Viscosity: The viscosities of the exemplified compositions were measured using a DIN4 Viscosity Flow Cup at 25° C. within two minutes of mixing all constituents of the compositions.
CRS Panel Preparation: Cold rolled steel (CRS) panels were sanded with a P180 sanding paper, then cleaned using PS4000 (available from Axalta) wipes and allowed to dry before spraying with the compositions to be evaluated. The samples to be tested were sprayed on the panels and baked for 30 minutes at 60° C.
Wave-Scan: Wave scanning, which is intended to simulate visual perception of an obtained coating, was performed using a Wavescan-DOI apparatus available from BYK-Gardner GmbH. The instrument provided a laser point light source which illuminated the specimen at a 60° angle: an associated detector measured the reflected light intensity at the equal but opposite angle. The longwave signal (structure size >0.6 mm) and shortwave signal (structure size <0.6 mm) were each divided from the measured signal using a mathematical filter function. The meter was rolled across the surface and measured, point-by-point, the optical profile of the surface across a defined distance. The long-term waviness value as tabulated below represents the variance of the longwave signal amplitude and has been normalized to a unitless value in the range of from 0 to 100, wherein 0 depicts the lowest variance (best) and 100 depicts the highest variance (worst). Similarly, the short-term waviness value represents the variance of the shortwave signal amplitude and has been normalized to a unitless value in the range of from 0 to 100, wherein 0 depicts the lowest variance (best) and 100 depicts the highest variance (worst).
Sanding Properties: A sanding rating of CRS panels was determined in accordance with United States Federal Test Method Specification No. 141B-6321 as documented in ASTM D3322-82(2017) Standard Practice for Testing Primers and Primer Surfacers Over Preformed Metal. Sanding may be performed under the conditions: by hand sanding; under bare down sanding; and, full panel sanding. A rating of from 1 to 7 is given, wherein 7 is highest performance rating and 1 the lowest performance rating.
Stone Chip Testing: This testing was performed using a gravelometer and Q-lab chilled iron Grit 4-5 mm stones. The stones were placed in the gravelometer hopper and the air supply was turned on and adjusted to an air pressure of 70 psi. Prepared CRS panels were placed in the dedicated holder, the instrument was turned on and the stones permitted to impact the panel for 10 seconds. The panels were then evaluated based on the ratings specifications of ISO 20567.

### Synthesis Example 1 and Comparative Synthesis Examples 1 and 2

The following procedure was followed independently for: Synthesis Example 1 (SE1) which provides an aqueous latex copolymer in accordance with the present disclosure; and, Comparative Synthesis Examples 1 and 2 (CSE1, CSE2), which provide an aqueous latex copolymer in accordance which is not in accordance with the present disclosure. The calculated glass transition temperatures of the Stage I and Stage II Monomer mixes for each of Synthesis Example 1 and Comparative Synthesis Examples 1 and 2 were identical.

To a 5 L 4-necked round bottom glass reactor equipped with a mechanical stirrer, a thermocouple, a condenser, and nitrogen purge, 637.3 g of deionized (DI) water, 5.0 g of a sodium α-olefin sulfonate (emulsifier, 40% active) and 3.0 g of sodium bicarbonate were added and heated to 79° C.

To a first Erlenmeyer flask, the ingredients of Table 1 herein below were added and stirred to form a stable monomer pre-emulsion, constituting the Stage I, Monomer Mix. The ammonium hydroxide was the last ingredient added to the flask for the purposes of pH adjustment. The calculated T_{g} of the monomer mix—intended to form the core of the latex particle—for each of SE1, CSE1 and CSE2 was +69° C.

TABLE 1

| | SE1 | CSE1 | CSE2 |
|---|---|---|---|
| Stage I Monomer Mix: Ingredients | (g) | (g) | (g) |
| Methyl methacrylate | 225.5 | 279.6 | 149.8 |
| n-butyl acrylate | 49.2 | 59.9 | 32.1 |
| Isobornyl Methacrylate | 49.2 | 59.9 | 32.1 |
| Methacrylic acid | 2.3 | 2.8 | 1.5 |
| SR 213 | 4.3 | 5.3 | 2.8 |
| Sipomer WAM-II | 8.0 | 9.8 | 5.2 |
| Deionized water | 140.0 | 170.5 | 91.4 |
| Sodium α-Olefin sulfonate (40% solids) | 5.8 | 7.0 | 3.8 |
| Aliphatic phosphate ester (6 moles ethylene oxide | 14.0 | 16.3 | 8.8 |
| (EO); ammonium salt solution; 25% solids) | | | |
| Ammonium Hydroxide (28 wt. % solution) | 0.8 | 0.9 | 0.9 |

To a second Erlenmeyer flask, the ingredients of Table 2 herein below were added and stirred to form a stable monomer pre-emulsion, constituting the Stage II, Monomer Mix. The ammonium hydroxide was the last ingredient added to the flask for the purposes of pH adjustment. The calculated Tg of the Stage II monomer mix for each of SE1, CSE1 and CSE2 was +0.7° C.

TABLE 2

| | SE1 | CSE1 | CSE2 |
|---|---|---|---|
| Stage II Monomer Mix: Ingredients | (g) | (g) | (g) |
| Methyl methacrylate | 201.4 | 248.1 | 143.4 |
| Butyl acrylate | 358.3 | 429.5 | 225.7 |
| Isobornyl methacrylate | 66.1 | 80.6 | 43.2 |
| Methacrylic acid | 15.5 | 19.0 | 10.1 |
| SIPOMER WAM-II | 22.2 | 27.1 | 14.5 |
| Veova 10 | 64.0 | 73.0 | 39.0 |
| Diacetone acrylamide (DAAM) | 41.6 | | |
| Hydroxyethyl methacrylate | | | 20.5 |
| (HEMA) | | | |
| Deionized water | 360.2 | 421.8 | 235.4 |
| Sodium α-Olefin sulfonate (40% | 10.3 | 12.5 | 6.8 |
| solids) | | | |
| Aliphatic phosphate ester (6 moles | 28.3 | 34.4 | 18.5 |
| ethylene oxide (EO); | | | |
| ammonium salt solution; 25% | | | |
| solids) | | | |
| Ammonium Hydroxide (28 wt. % | 2.9 | 3.6 | 2.0 |
| solution) | | | |

To a third Erlenmeyer flask, the ingredients of Table 3 herein below were added and stirred to form a stable monomer pre-emulsion, constituting the Stage III, Monomer Mix. The molecular weight of this third stage shell was controlled through the use of 1-dodecanethiol as a chain transfer agent.

TABLE 3

| | SE1 | CSE1 | CSE2 |
|---|---|---|---|
| Stage III Monomer Mix: Ingredients | (g) | (g) | (g) |
| n-butyl methacrylate | 18.2 | 23.0 | 12.0 |
| SIPOMER WAM-II | 1.3 | 1.9 | 0.8 |
| Methacrylic acid | 2.5 | 3.0 | 1.6 |
| 1-Dodecanethiol | 0.4 | 0.5 | 0.3 |

81.0 g of the monomer pre-emulsion prepared from Stage II Monomer mix (Table 2) and 24.1 ml of 12.9 wt. % aqueous ammonium persulfate (APS) initiator solution were added to the reactor at 79° C. to form the polymerization seeds. After stirring at 100 rpm for 15 minutes at 79° C., an exothermal peak from the seed reaction was observed and the batch color turned from white milky to a blueish hue; the delayed feed of the Stage I monomer pre-emulsion (Table 1), together with 204 ml of 2.1% ammonium persulfate (APS) aqueous initiator solution was then started. The delayed feed of said Stage I (core) monomer emulsion was performed over 50 minutes; the 204 ml of initiator solution was added at a constant rate over the duration of addition of the monomer emulsion feed.

Immediately after the Stage I monomer feed was completed, the remaining Stage II monomer pre-emulsion (shell) was started at a feed rate such that the Stage II monomer emulsion was completed in 130 minutes. The feed of initiator solution (2.1% aq. ammonium persulfate (APS)) was continued for the Stage II monomer feed.

Immediately after the end of the Stage II monomer feed, the Stage III Monomer mix was fed over a duration of 3 minutes. The reactor was then held at a temperature of 82° C. under agitation for 1 hour, before being permitted to cool to 65° C. for the purposes of redox chaser addition.

Said redox chasers—20.3 ml of 14.7 wt. % t-butyl hydroperoxide and 19.7 ml of 12.2 wt. % Bruggolite® FF6M—were added as shots at 5 minute intervals from one another for the purposes of reducing residual monomers.

The properties of each produced latex are listed in Table 4 herein below.

TABLE 4

| | | | | | | Acid | |
|---|---|---|---|---|---|---|---|
| | | | | Dv50 | | Value | Keto |
| Synthesis | Solids | | MFFT | Particle | η | (mg | (% vs |
| Example | (wt. %) | pH | (° C.) | size (nm) | (cPs) | KOH/g) | mons.) |
| SE1 | 46.6 | 9.3 | 16.2 | 138 | 198 | 7.4 | 3.7 |
| CSE1 | 45.1 | 6.0 | 18.0 | 127 | 43 | 8.2 | 0 |
| CSE2 | 43.7 | 8.1 | 27.8 | 132 | 92 | 9.3 | 0 |

### Synthesis Example 2 and Comparative Synthesis Example 3

The following procedure was followed independently for: Synthesis Example 2 (SE2) which provides an aqueous latex copolymer in accordance with the present disclosure; and, Comparative Synthesis Example 3 (CSE3), which provide an aqueous latex copolymer in accordance which is not in accordance with the present disclosure. The calculated glass transition temperatures of the Stage I Monomer mix for Synthesis Example 2 was 53° C. The calculated glass transition temperatures of the Stage I Monomer mix for Comparative Synthesis Example 3 was 53° C.

To a 5 L 4-necked round bottom glass reactor equipped with a mechanical stirrer, a thermocouple, a condenser, and nitrogen purge, 365 g of deionized (DI) water, 1.6 g of a sodium α-olefin sulfonate (emulsifier, 40% active), 1.5 g of sodium dodecylbenzene sulfonate and 1.0 g of sodium bicarbonate were added and heated to 79° C.

To a first Erlenmeyer flask, the ingredients of Table 5 herein below were added and stirred to form a stable monomer pre-emulsion, constituting the Stage I, Monomer Mix. The ammonium hydroxide was the last ingredient added to the flask for the purposes of pH adjustment.

TABLE 5

| | SE2 | CSE3 |
|---|---|---|
| Stage I Monomer Mix: Ingredients | (g) | (g) |
| Hydroxyethyl methacrylate (HEMA) | 10.9 | 15.0 |
| Methyl methacrylate | 58.5 | 80.5 |
| n-Butyl Acrylate | 32.4 | 44.6 |
| Styrene | 52.5 | 72.3 |
| Methacrylic acid | 1.0 | 1.1 |
| SR213 | 1.1 | 1.5 |
| Sipomer WAM-II | 2.5 | 3.5 |
| Deionized water | 79.0 | 79.0 |
| Sodium α-Olefin sulfonate (40% solids) | 1.5 | 2.1 |
| Aliphatic phosphate ester (6 moles ethylene oxide (EO); | 9.0 | 9.0 |
| ammonium salt solution; 25% solids) | | |
| Ammonium Hydroxide (28 wt. % solution) | 0.5 | 0.5 |

To a second Erlenmeyer flask, the ingredients of Table 6 herein below were added and stirred to form a stable monomer pre-emulsion, constituting the Stage II, Monomer Mix. The ammonium hydroxide was the last ingredient added to the flask for the purposes of pH adjustment. The calculated glass transition temperatures of the Stage II Monomer mix for Synthesis Example 2 was 0.3° C. The calculated glass transition temperatures of the Stage II Monomer mix for Comparative Synthesis Example 3 was −0.2° C.

TABLE 6

| | SE2 | CSE3 |
|---|---|---|
| Stage II Monomer Mix: Ingredients | (g) | (g) |
| Methyl Methacrylate | | 71.5 |
| n-Butyl methacrylate | 77.3 | 87.3 |
| n-Butyl acrylate | 302.1 | 279.0 |
| Methacrylic Acid | 8.9 | 8.4 |
| Sipomer WAM II | 15.6 | 14.1 |
| Styrene | 211.4 | 132.2 |
| Diacetone Acrylamide | 22.4 | |
| Deionized water | 220.7 | 200.0 |
| Sodium α-Olefin sulfonate (40% solids) | 6.1 | 5.5 |
| Aliphatic phosphate ester (6 moles ethylene oxide (EO); | 24.8 | 23.0 |
| ammonium salt solution; 25% solids) | | |
| Hitenol BC 1025 (25%) | 8.8 | 8.0 |
| Ammonium Hydroxide (28 wt. % solution) | 1.5 | 1.5 |

45.0 g of the monomer pre-emulsion prepared from Stage II Monomer mix (Table 6) and 24.1 ml of 12.9 wt. % aqueous ammonium persulfate (APS) initiator solution were added to the reactor at 79° C. to form the polymerization seeds. After stirring at 100 rpm for 15 minutes at 79° C., an exothermal peak from the seed reaction was observed and the batch color turned from white milky to a blueish hue; the delayed feed of the Stage I monomer pre-emulsion (Table 5), together with 204 ml of 2.1% ammonium persulfate (APS) aqueous initiator solution was then started. The delayed feed of said Stage I (core) monomer emulsion was performed over 50 minutes; the 204 ml of initiator solution was added at a constant rate over the duration of addition of the monomer emulsion feed.

Immediately after the Stage I monomer feed was completed, the remaining Stage II monomer pre-emulsion (shell) was started at a feed rate such that the Stage II monomer emulsion was completed in 130 minutes. The feed of initiator solution (2.1% aq. ammonium persulfate (APS)) was continued for the Stage II monomer feed.

The reactor was then held at a temperature of 82° C. under agitation for 1 hour, before being permitted to cool to 65° C. for the purposes of redox chaser addition.

Said redox chasers—9.8 ml of 11.2 wt. % t-butyl hydroperoxide and 9.6 ml of 9.3 wt. % Bruggolite® FF6M—were added as shots at 5 minute intervals from one another for the purposes of reducing residual monomers.

The properties of produced latex are listed in Table 7 herein below.

TABLE 7

| | | | | | | | |
|---|---|---|---|---|---|---|---|
| | | | | | | Acid | |
| | | | | Dv50 | | Value | Keto |
| Synthesis | Solids | | MFFT | Particle | η | (mg | (% vs |
| Example | (wt. %) | pH | (° C.) | size (nm) | (cPs) | KOH/g) | mons.) |

| | | | | | | |
|---|---|---|---|---|---|---|
| SE2 | 46.4 | 8.2 | 131 | 111 | 8.2 | 2.8 |
| CSE3 | 48.5 | 6.1 | 141 | 151 | 8.5 | 0 |

### Millbase Preparation:

To form a millbase (herein after MB1) to be included in the two-part (2K) composition, the following components were ground together: 20 parts by weight of barium sulphate; 13 parts by weight of talcum; 18 parts by weight of aluminum silicate; 17 parts by weight of titanium dioxide; 4 parts by weight of Dispersant 1; 8 parts by weight of Dispersant 2; 1.4 parts by weight of heavy naphtha; 1 part by weight of pentanol; 0.1 parts by weight of aminomethyl propanol; 1.7 parts by weight of a 50% Surfynol 104 solution in ethylene glycol mono butylether; and, 15.5 parts by weight of deionized water.

### EXAMPLES

Pre-Preparation of a Black Dispersion: In accordance with the ingredients presented in Table 8 below, the water, Solsperse 27000, surfactant solution and amino methyl propanol were added to a container and mixed for 15 minutes using an air-mixer. The carbon black was added to the container under mixing using said air-mixer, after which addition mixing is continued for a further 30 minutes. The obtained dispersion was ground with an LMZ mill and then filtered through a 10 μm filter.

TABLE 8

| Ingredient | Weight (g) |
|---|---|
| DI Water | 68.0 |
| Solsperse 27000 | 12.8 |
| Surfynol 104 | 1.0 |
| Aminomethyl propanol | 2.2 |
| Carbon Black | 16.0 |

The coating compositions having the ingredients listed in Table 9 below were prepared under mixing in a high speed mixer-disperser operated at 1000 rpm. To facilitate the formation of a homogeneous dispersion, the aqueous latex and adipic acid dihydrazide were first mixed for a duration of 10 minutes, after which the mill base and the aforementioned black dispersion (Table 8) were added thereto and mixed for a further 30 minutes. A blend of ethylene glycol ether acetate and epoxysilane were combined with the obtained mixture to form the final composition.

TABLE 9

| | | Compar- | Compar- | | Compar- |
|---|---|---|---|---|---|
| | | ative | ative | | ative |
| | Example 1 | Example 1 | Example 2 | Example 2 | Example 3 |
| | (wt. % of | (wt. % of | (wt. % of | (wt. % of | (wt. % of |
| | composi- | composi- | composi- | composi- | composi- |
| Ingredient | tion) | tion) | tion | tion) | tion) |
| Aqueous | 40.35 | | | | |
| Latex of | | | | | |
| SE1 | | | | | |
| Aqueous | | 40.75 | | | |
| Latex of | | | | | |
| CSE1 | | | | | |
| Aqueous | | | 39.25 | | |
| Latex of | | | | | |
| CSE2 | | | | | |
| Aqueous | | | | 38.70 | |
| Latex of | | | | | |
| SE2 | | | | | |
| Aqueous | | | | | 39.05 |
| Latex of | | | | | |
| CSE3 | | | | | |
| Adipic | 0.40 | | | 0.35 | |
| Dihydrazide | | | | | |
| (ADH) | | | | | |
| MB1 | 58.95 | 58.95 | 56.78 | 56.46 | 56.46 |
| Black | 0.30 | 0.30 | 0.29 | 0.28 | 0.28 |
| Dispersion | | | | | |
| Activator | | | 1.71 | 2.24 | 2.24 |
| Ethylene | | | 1.97 | | |
| glycol | | | | | |
| monobutyl | | | | | |
| ether | | | | | |
| acetate | | | | | |
| Pentanol | | | | 1.97 | 1.97 |

The results of the tests performed on the above described coating compositions are provided in Table 10 below.

TABLE 10

| | | Compar- | Compar- | | Compar- |
|---|---|---|---|---|---|
| | | ative | ative | | ative |
| | Exam- | Exam- | Exam- | Exam- | Exam- |
| Test Performed | ple 1 | ple 1 | ple 2 | ple 2 | ple 3 |
| DIN4 Viscosity | 21.26 | 16.09 | 28.4 | 29.52 | 30.31 |
| (seconds) | | | | | |
| Hand Sanding | 7.0 | 5.5 | 6.5 | 6.5 | 5.5 |
| Rating | | | | | |
| Bare Down | 6.0 | 5.5 | 5.0 | 5.5 | 4.0 |
| Sanding Rating | | | | | |
| Full Panel | 6.0 | 6.0 | 5.5 | | |
| Sanding | | | | | |
| Rating | | | | | |
| Short-Term | 28.6 | 14.8 | | 36.9 | 44.6 |
| Waviness Value | | | | | |
| Long-Term | 10.6 | 32.0 | | 9.4 | 19.8 |
| Waviness Value | | | | | |
| Stone Chip Test | 2.0 | 2.5 | | 2.0 | 2.0 |
| (Rating) | | | | | |

The Examples according to the present disclosure display excellent sanding ratings. Moreover, the Examples according to the present disclosure show: low variance in both short-term and long-term waviness; and, good durability in stone-chip resistance testing.

It should be understood that various changes and modifications to the exemplary embodiments described herein will be apparent to those skilled in the art. Such changes and modifications can be made without departing from the spirit and scope of the present subject matter and without diminishing its intended advantages. It is therefore intended that such changes and modifications be covered by the appended claims. Also, it should be appreciated that the features of the dependent claims may be embodied in the compositions and methods of each of the independent claims.

Many modifications to and other embodiments of the disclosure set forth herein will come to mind to one skilled in the art to which this disclosure pertains, once having the benefit of the teachings in the foregoing description. Therefore, it is understood that the disclosure is not limited to the specific embodiments disclosed, and that modifications and other embodiments are intended to be included within the scope of the appended claims.

What is claimed is:

1. A water-borne coating composition comprising:
water;
a) a binder comprising:
(a1) a core-shell latex copolymer having pendant carbonyl groups, said core-shell latex copolymer comprising a core copolymer and a shell copolymer disposed about said core polymer, each of said core copolymer and said shell copolymer independently comprising the residues of:
i) at least one (meth)acrylate monomer represented by Formula MA: 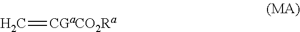
wherein: G^{a} is hydrogen, halogen or methyl; and,
R^{a} is: C₁-C₁₈ alkyl; C₂-C₁₈ heteroalkyl; C₃-C₁₈ cycloalkyl; C₂-C₈ heterocycloalkyl; C₂-C₈ alkenyl; C₂-C₈ alkynyl; C₆-C₁₈ aryl, C₁-C₉ heteroaryl, C₇-C₁₈ alkoxyaryl, C₇-C₁₈ alkaryl or C₇-C₁₈ aralkyl; and,
optionally ii) at least one vinyl aromatic monomer;
optionally iii) at least one monomer having at least two (meth)acrylate groups and having a weight average molecular weight (Mw) of at most 600 Daltons; and,
optionally iv) at least one hydroxyl functional ethylenically unsaturated monomer;
wherein at least one of the core copolymer and shell copolymer comprises the residues of:
v) at least one carbonyl functional ethylenically unsaturated monomer; and,
b) a crosslinker comprising:
(b1) at least one polyhydrazide compound having at least two hydrazide groups of the formula —C(═O)—NH—N(R^{h})(Rⁱ), wherein R^{h} and Rⁱ are independently H or C₁-C₁₂ alkyl, wherein the molar ratio of hydrazide groups to carbonyl groups in the composition is from about 5:1 to about 1:5.

2. The coating composition according to claim 1, wherein the composition comprises, based on the total weight of the composition:
from about 10 to about 70 wt. % of water;
from about 5 to about 50 wt. % of (a1) said core-shell latex copolymer having pendant carbonyl groups; and,
from about 5 to about 30 wt. % of (c) said at least one polyhydrazide compound having at least two hydrazide groups of the formula —C(═O)—NH—N(R^{h})(Rⁱ), wherein R^{h} and Rⁱ are independently H or C₁-C₁₂ alkyl.

3. The coating composition according to claim 1, wherein:
the molar ratio of hydrazide groups to carbonyl groups in the composition is from about 3:1 to about 1:3.

4. The coating composition according to claim 1, having a volatile organic compound (VOC) content, as measured in accordance with ISO 11890-2:2006, of at most about 420 g/l.

5. The coating composition according to claim 1, having a minimum film forming temperature of less than about 40° C.

6. The coating composition according to claim 1, wherein:
the calculated glass transition temperature of the core copolymer (T_{g}^{c}) is from about 20 to about 80° C.; and,
the calculated glass transition temperature of the shell copolymer (T_{g}^{s}) is from about −30 to about 30° C. and is subject to the condition that T_{g}^{c} is at least about 20° C. greater than T_{g}^{s}.

7. The coating composition according to claim 1, wherein:
the core copolymer contributes from about 10 to about 70 wt. % of the total weight of monomer residues in said core-shell latex copolymer; and,
the shell copolymer contributes from about 90 to about 30 wt. % of the total weight of monomer residues in said core-shell latex copolymer.

8. The coating composition according to claim 1, wherein monomer component v) comprises at least one monomer chosen from: acrolein; methacrolein; 4-vinyl-benzaldehyde; diacetone acrylamide; diacetone methacrylamide; diacetone acrylate; diacetone methacrylate; allyl acetoacetate; vinyl acetoacetate; vinyl acetoacetamide; acetoacetoxy(C₁-C₆)alkyl (meth)acrylates; butanediol-1,4-acrylate-acetylacetate; vinyl (C₁-C₆)alkyl ketones; and, mixtures thereof.

9. The coating composition according to claim 1, wherein the core-shell latex copolymer further comprises residues of:
vi) at least one monomer chosen from monomers of Formula U1, monomers of Formula CU1 and mixtures thereof: 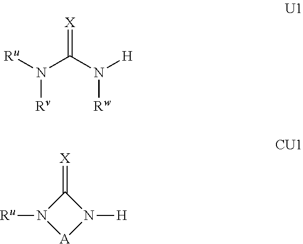
wherein: X is O or S;
A is C₂-C₃ alkylene;
R^{u} is a group of the formula -(Alk-L)_{y}-R^{x};
R^{v} and R^{w} are independently H or C₁-C₈ alkyl;
y is 0 or 1;
Alk is C₂-C₈ alkylene;
L is —O— or —NR^{z}—, wherein R^{z} is H or C₁-C₈ alkyl; and,
R^{x} is 2-(2-carboxyacrylamide)ethyl, vinyl, allyl, isopropenyl, acryloyl, methacryloyl or 2-hydroxy-3-(allyloxy)propyl.

10. The coating composition according to claim 9, wherein in Formula U1 or Formula CU1:
X is O;
A is C₂ alkylene; and,
Alk is C₂-C₆ alkylene.

11. The coating composition according to claim 9, wherein monomer component vi) comprises at least one monomer chosen from: N-(meth)acryoyl urea; N-vinylethyleneurea; N-vinyloxyethylethyleneurea; N-(2-acryloyloxyethyl)ethylene urea; N-(2-methacryloyloxyethyl)ethylene urea; N-(acrylamidomethyl)ethylene urea; N-(2-methacrylamidoethyl)ethylene urea (MAEEU); and, mixtures thereof.

12. The coating composition according to claim 1, wherein the core-shell latex copolymer further comprises residues of:
vii) at least one (meth)acrylate monomer having phosphate or phosphonate functionality.

13. The coating composition according to claim 12, wherein monomer component vii) comprises at least one monomer chosen from: 2-monomethacryloxyethyl phosphate; bis(2-methacryloxyethyl) phosphate; 2-acryloyloxyethyl phosphate; bis-(2-acryloyloxyethyl) phosphate; methyl-(2-methacryloyloxyethyl) phosphate; ethyl methacryloyloxyethyl phosphate; methyl acryloyloxyethyl ethyl phosphate; acryloyloxyethyl phosphate; 2-hydroxyethylmethacrylate phosphate; 10-[(2-methylprop-2-enoyl)oxy]decyl dihydrogen phosphate (10-methacryloyloxydecyl dihydrogen phosphate); and, mixtures thereof.

14. The coating composition according to claim 1, wherein the binder further comprises:
(a2) at least one polymer which is distinct from the core-shell latex copolymer (a1) and which has a pendant functional group which is reactive with hydrazide groups.

15. The coating composition according to claim 14, wherein the ratio by weight of solids of constituent (a1) the core-shell latex copolymer to solids of constituent (a2) is from about 100:1 to about 100:50, and wherein (a2) is chosen from: poly(meth)acrylates having pendant carbonyl groups; polyurethanes having pendant carbonyl groups; polyesters having pendant carbonyl groups; and, mixtures thereof.

16. The coating composition according to claim 1, wherein (b1) comprises at least one dihydrazide having the formula (DH1): 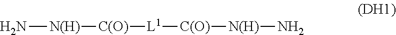
wherein: L¹ is a divalent linking group chosen from a covalent bond, C₁-C₁₈ alkylene, C₂-C₁₈ alkenylene, C₃-C₁₈ cycloalkylene or C₆-C₁₈ arylene.

17. The coating composition according to claim 16, wherein (b1) comprises at least one dihydrazide chosen from: maleic acid dihydrazide; fumaric acid dihydrazide; itaconic acid dihydrazide; oxalic acid dihydrazide; malonic acid dihydrazide; succinic acid dihydrazide; adipic acid dihydrazide (ADH); phthalic acid dihydrazide; terephthalic acid dihydrazide; glutaric acid dihydrazide; sebacic acid dihydrazide; cyclohexane-1,4-dicarbohydrazide; azelaic acid dihydrazide; and, mixtures thereof.

18. A cured product obtained from the water-borne coating composition of claim 1.

19. An article comprising:
a metallic substrate; and,
a multilayer coating disposed on the metallic substrate, wherein at least one layer of the multilayer coating comprises the cured product of claim 18.

20. The article according to claim 19, wherein the multilayer coating comprises:
a primer layer comprising the cured product and disposed on and in direct contact with the substrate;
at least one base coat layer comprising a color and/or visual effect imparting compound, wherein at least one base coat layer is disposed on and in direct contact with the primer layer; and,
a clear coat layer disposed on and in direct contact with at least one base coat layer.
